(19) United States
(12) Patent Application Publication
(10) Pub. No.: US 2026/0175568 A1
(43) Pub. Date: Jun. 25, 2026

(54) LIQUID DISCHARGE APPARATUS

(71) Applicant: SEIKO EPSON CORPORATION, Tokyo (JP)

(72) Inventor: Koji KITAZAWA, Shiojiri (JP)

(21) Appl. No.: 19/428,401

(22) Filed: Dec. 22, 2025

(30) Foreign Application Priority Data
Dec. 24, 2024 (JP) 2024-227991

(51) Int. Cl. B41J 2/045; B41J 2/165

(52) U.S. Cl. CPC B41J 2/0455; B41J 2/0451; B41J 2/04541; B41J 2/04548; B41J 2/04581; B41J 2/16526; B41J 2/16535

(57) ABSTRACT

In a liquid discharge apparatus, when a state determination circuit that determines a state of a plurality of discharge sections determines that an abnormality occurs in a first discharge section, a first switch circuit that corresponds to a first piezoelectric element for discharging a liquid from the first discharge section does not supply a drive signal to the first piezoelectric element in a discharge period during which the liquid is discharged from a print head, and when the state determination circuit that determines the state of the plurality of discharge sections determines that the abnormality occurs in a second discharge section, a second switch circuit that corresponds to a second piezoelectric element for discharging the liquid from the second discharge section does not supply the drive signal to the second piezoelectric element in the discharge period.

The present application is based on, and claims priority from JP Application Serial Number 2024-227991, filed Dec. 24, 2024, the disclosure of which is hereby incorporated by reference herein in its entirety.

### BACKGROUND

### 1. Technical Field

The present disclosure relates to a liquid discharge apparatus.

### 2. Related Art

A liquid discharge apparatus (liquid ejecting apparatus) that discharges a liquid by driving a piezoelectric element and forms an image on a medium by the discharged liquid landing on the medium is known. In such a liquid discharge apparatus, a potential difference is generated between both ends of the piezoelectric element to drive the piezoelectric element, and the liquid is discharged toward the medium by driving the piezoelectric element.

In the liquid discharge apparatus having such a configuration, when an abnormality occurs in the piezoelectric element, the discharge characteristics of the liquid may deteriorate, and the quality of the image formed at the medium may deteriorate. In response to such a problem, JP-A-2023-137369 discloses a liquid discharge apparatus (liquid ejecting apparatus) including a piezoelectric element in which a possibility that an abnormality occurs in the piezoelectric element driven to discharge a liquid is reduced.

However, with only the technique described in JP-A-2023-137369, the occurrence of an abnormality in the piezoelectric element cannot be completely prevented, and thus, from the viewpoint of reducing the possibility that the quality of the image formed at the medium deteriorates when an abnormality occurs in the piezoelectric element and reducing the possibility that the convenience of the liquid discharge apparatus is impaired, the technique described in JP-A-2023-137369 is not sufficient, and there is room for further improvement.

### SUMMARY

According to an aspect of the present disclosure, there is provided a liquid discharge apparatus including a print head having a plurality of discharge sections including a first discharge section configured to discharge a liquid by driving a first piezoelectric element and a second discharge section configured to discharge the liquid by driving a second piezoelectric element, a drive circuit configured to output a drive signal supplied to one end of the first piezoelectric element and one end of the second piezoelectric element, a reference voltage circuit configured to output a reference voltage signal supplied to another end of the first piezoelectric element and another end of the second piezoelectric element, a first switch circuit configured to switch whether or not to supply the drive signal to the one end of the first piezoelectric element, a second switch circuit configured to switch whether or not to supply the drive signal to the one end of the second piezoelectric element, a state determination circuit configured to determine a state of the plurality of discharge sections, and a sink circuit configured to switch an impedance value between a first wiring through which the reference voltage signal propagates and a second wiring through which a signal having a lower potential than the reference voltage signal propagates, in which when the state determination circuit determines that an abnormality occurs in the first discharge section, the first switch circuit does not supply the drive signal to the first piezoelectric element in a discharge period during which the liquid is discharged from the print head, and when the state determination circuit determines that the abnormality occurs in the second discharge section, the second switch circuit does not supply the drive signal to the second piezoelectric element in the discharge period.

### BRIEF DESCRIPTION OF THE DRAWINGS

FIG. 1 is a diagram illustrating an example of a functional configuration of a liquid discharge apparatus.

FIG. 2 is a diagram illustrating an example of a schematic internal structure of the liquid discharge apparatus.

FIG. 3 is a diagram illustrating a schematic structure of a discharge section.

FIG. 4 is a diagram illustrating an example of an arrangement of nozzles.

FIG. 5 is a diagram illustrating an example of a configuration of a drive circuit.

FIG. 6 is a diagram illustrating an example of a configuration of a reference voltage circuit.

FIG. 7 is a diagram illustrating an example of a configuration of a sink circuit.

FIG. 8 is a diagram illustrating an example of a functional configuration of a head unit.

FIG. 9 is a diagram for explaining an example of various signals input to a coupling state designation circuit.

FIG. 10 is a diagram illustrating an example of a configuration of a waveform shaping circuit.

FIG. 11 is a diagram for explaining an example of various signals output by a control unit in a period during which discharge processing is executed.

FIG. 12 is a diagram illustrating an example of a relationship between an individual designation signal Sd[m] and coupling state designation signals Qc[m] and Qs[m] in the period during which the discharge processing is executed.

FIG. 13 is a diagram for explaining an example of various signals input to a supply switching circuit of the head unit in a period during which determination processing is executed.

FIG. 14 is a diagram illustrating an example of a relationship between the individual designation signal Sd[m] and coupling state designation signals Qc[m] and Qs[m] in the period during which the determination processing is executed.

FIG. 15 is a diagram illustrating an example of a relationship between the individual designation signal Sd[m] and coupling state designation signals Qf, Q1, and Q2 in the period during which the determination processing is executed.

FIG. 16 is a diagram for explaining an example of an operation of acquiring a detection potential signal based on a signal corresponding to the residual vibration generated in a discharge section to be inspected.

FIG. 17 is a diagram illustrating an example of pump suction processing.

FIGS. 18A and 18B are diagrams illustrating examples of wiping processing.

FIG. 19 is a diagram for explaining an operation of the liquid discharge apparatus.

### DESCRIPTION OF EMBODIMENTS

Hereinafter, preferred embodiments of the present disclosure will be described with reference to the drawings. The drawings to be used are for convenience of description. Embodiments to be described below do not inappropriately limit the contents of the present disclosure described in the claims. In addition, not all of configurations to be described below are necessarily essential requirements of the present disclosure.

### 1. Overview of Liquid Discharge Apparatus

A liquid discharge apparatus 1 of the present embodiment will be described as an example of an ink jet printer that discharges ink, which is an example of a liquid, onto a medium such as recording paper to form an image on the medium. The liquid discharge apparatus 1 is not limited to the ink jet printer, and may be a coloring material discharge apparatus used for manufacturing a color filter such as a liquid crystal display, an electrode material discharge apparatus used for forming an electrode such as an organic EL display or a field emission display (FED), a bioorganic substance discharge apparatus used for manufacturing a biochip, a stereolithography apparatus, a textile printing apparatus, and the like.

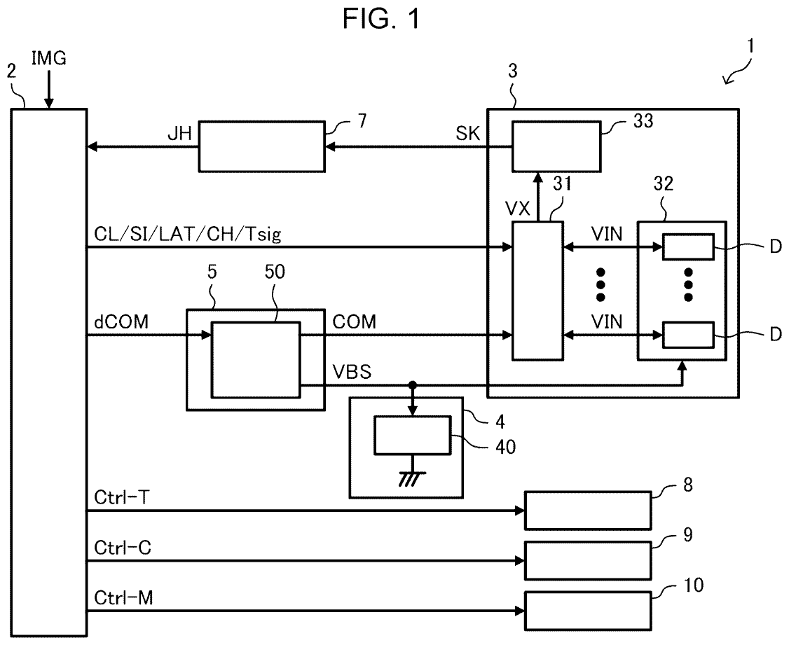

FIG. 1 is a diagram illustrating an example of a functional configuration of the liquid discharge apparatus 1. The liquid discharge apparatus 1 of the present embodiment forms an image on a medium according to an image data signal IMG input from an external device such as a computer. As illustrated in FIG. 1, the liquid discharge apparatus 1 includes a control unit 2, a head unit 3, a sink unit 4, a drive circuit unit 5, a determination unit 7, a transport unit 8, a carriage movement unit 9, and a maintenance unit 10.

The control unit 2 controls each configuration of the liquid discharge apparatus 1 including the head unit 3, the sink unit 4, the drive circuit unit 5, the determination unit 7, the transport unit 8, the carriage movement unit 9, and the maintenance unit 10. Such a control unit 2 includes one or a plurality of central processing units (CPU) and a memory circuit. The control unit 2 may include a programmable logic device such as a field-programmable gate array (FPGA), instead of the CPU or in addition to the CPU.

The image data signal IMG is input to the control unit 2. The control unit 2 generates a signal for controlling the operation of each section of the liquid discharge apparatus 1, such as a transport control signal Ctrl-T, a carriage control signal Ctrl-C, a maintenance control signal Ctrl-M, a clock signal CL, a print data signal SI, a latch signal LAT, a change signal CH, a period designation signal Tsig, and a drive waveform designation signal dCOM, according to the input image data signal IMG, and outputs the signal to the corresponding configuration.

The drive circuit unit 5 includes a drive circuit 50. The drive waveform designation signal dCOM is input to the drive circuit 50. The drive circuit 50 generates a drive signal COM by amplifying a signal waveform defined by the input drive waveform designation signal dCOM. Further, the drive circuit 50 generates a reference voltage signal VBS together with the drive signal COM. The drive signal COM and the reference voltage signal VBS generated by the drive circuit 50 are output from the drive circuit unit 5.

The sink unit 4 includes a sink circuit 40. The sink circuit 40 is coupled to a wiring through which the reference voltage signal VBS propagates and to a wiring of a ground potential. The sink circuit 40 releases the charge of the wiring through which the reference voltage signal VBS propagates to the wiring through which the ground potential propagates, according to a voltage value of the reference voltage signal VBS.

The clock signal CL, the print data signal SI, the latch signal LAT, the change signal CH, and the period designation signal Tsig are input to the head unit 3. Further, the drive signal COM and the reference voltage signal VBS output by the drive circuit unit 5 are also input to the head unit 3. The head unit 3 controls the supply of the drive signal COM to a plurality of discharge sections D included in a recording head 32, which will be described later, in each of the periods defined by the latch signal LAT, the change signal CH, and the period designation signal Tsig, in accordance with the print data signal SI propagated in synchronization with the clock signal CL. As a result, in the operation of the plurality of discharge sections D in each of the periods defined by the latch signal LAT, the change signal CH, and the period designation signal Tsig, discharge of ink from the plurality of discharge sections D is individually controlled.

Specifically, the head unit 3 includes a supply switching circuit 31, the recording head 32, and a detection circuit 33. Further, the recording head 32 has a plurality of discharge sections D. Here, in the following description, the recording head 32 will be described as having M discharge sections D. When the M discharge sections D of the recording head 32 are individually designated and described, the M discharge sections D may be referred to as discharge sections D[1] to D[M]. At this time, when the description is made by designating any m-th discharge section D among the M discharge sections D of the recording head 32, the m-th discharge section D may be referred to as a discharge section D[m]. M is a natural number that satisfies “M≥1”, and m is any natural number that satisfies “1≤m≤M”. Further, in the following description, when components, signals, or the like of the liquid discharge apparatus 1 correspond to the discharge section D[m] among the M discharge sections D, the components, signals, or the like may be given a subscript [m] in the reference numerals.

The clock signal CL, the print data signal SI, the latch signal LAT, the change signal CH, the period designation signal Tsig, and the drive signal COM are input to the supply switching circuit 31. The supply switching circuit 31 switches whether or not to supply the drive signal COM, as a supply drive signal VIN, to the corresponding discharge section D based on the print data signal SI at each of the timings defined by the latch signal LAT, the change signal CH, and the period designation signal Tsig. The supply drive signal VIN is supplied to a piezoelectric element PZ, which will be described later, included in the discharge section D, whereby the piezoelectric element PZ is driven. Then, an amount of ink corresponding to a drive amount of the piezoelectric element PZ is discharged from the discharge section D.

In addition, the supply switching circuit 31 switches whether or not to acquire a signal corresponding to the residual vibration generated in the discharge section D to be inspected based on the print data signal SI and to supply the signal to the detection circuit 33 as a detection potential signal VX at each of the timings defined by the latch signal LAT, the change signal CH, and the period designation signal Tsig.

The detection circuit 33 generates a detection signal SK based on the detection potential signal VX supplied through the supply switching circuit 31, and outputs the detection signal SK from the head unit 3. Specifically, the detection circuit 33 amplifies the input detection potential signal VX, removes the noise component, and then converts the signal into a digital signal to generate a detection signal SK, and outputs the detection signal SK from the head unit 3.

The detection signal SK that is output from the head unit 3 is input to the determination unit 7. The determination unit 7 determines whether or not the ink discharge state of the discharge section D to be inspected is normal based on the input detection signal SK, that is, whether or not the discharge section D to be inspected is in a normal discharge state. Specifically, the determination unit 7 reads, for example, predetermined determination threshold value information and correction value information from a non-illustrated memory circuit including a non-volatile memory such as a read-only memory (ROM) or a flash memory. The determination unit 7 corrects the input detection signal SK in accordance with the correction value information that is read, and compares the corrected signal with predetermined determination threshold value information. The determination unit 7 determines, based on the comparison result, whether or not a discharge abnormality occurs in the discharge section D to be inspected, that is, whether or not the discharge section D to be inspected is in a normal discharge state. Thereafter, the determination unit 7 generates a state determination signal JH indicating the determination result, and outputs the state determination signal JH to the control unit 2.

Here, in the following description, determining whether or not the discharge abnormality occurs in the discharge section D to be inspected, that is, determining whether or not the discharge section D to be inspected is in a normal discharge state, may be simply referred to as determining a state of the discharge section D to be inspected. The discharge abnormality is a collective term for a state in which an abnormality occurs in a discharge state of the ink from the discharge section D to be inspected, and a state in which the ink cannot be accurately discharged from the discharge section D to be inspected. Such a discharge abnormality includes, for example, a state in which the ink cannot be discharged from the discharge section D, a state in which the ink is discharged from the discharge section D in an amount different from the discharge amount of the ink defined by the drive signal COM, a state in which the ink is discharged from the discharge section D at a speed different from the discharge speed of the ink defined by the drive signal COM, and the like.

The transport control signal Ctrl-T is input to the transport unit 8. The transport unit 8 controls the transport of the medium on which the ink lands in accordance with the input transport control signal Ctrl-T. The carriage control signal Ctrl-C is input to the carriage movement unit 9. The carriage movement unit 9 controls the movement of the carriage, which will be described later, after the head unit 3 is mounted. As a result, the control unit 2 controls a relative position between the head unit 3 that discharges the ink and the medium on which the ink lands.

The maintenance control signal Ctrl-M is input to the maintenance unit 10. The maintenance unit 10 attempts to recover the state of the discharge section D in which the discharge abnormality occurs by executing the maintenance processing according to the input maintenance control signal Ctrl-M.

In the liquid discharge apparatus 1 as described above, when the discharge processing of forming an image on the medium in accordance with the image data signal IMG is executed by discharging the ink, the control unit 2 generates a signal such as the print data signal SI for controlling the head unit 3 to discharge the ink based on the input image data signal IMG, outputs the signal to the head unit 3, generates the drive waveform designation signal dCOM for controlling the drive circuit unit 5 to output the drive signal COM for driving the discharge section D so that the ink is discharged, and outputs the drive waveform designation signal dCOM to the drive circuit unit 5. At this time, the control unit 2 generates and outputs the transport control signal Ctrl-T for controlling the transport unit 8 and the carriage control signal Ctrl-C for controlling the carriage movement unit 9. Accordingly, the ink discharged from the discharge section D lands at a desired position on the medium, and an image corresponding to the image data signal IMG is formed at the medium.

In addition, when the determination processing of determining the state of the discharge section D is executed, the control unit 2 generates a signal such as the print data signal SI for determining the state of the discharge section D to be inspected, outputs the signal to the head unit 3, generates the drive waveform designation signal dCOM for controlling the drive circuit unit 5 to output the drive signal COM for determining the state of the discharge section D, and outputs the drive waveform designation signal dCOM to the drive circuit unit 5. Accordingly, the detection potential signal VX corresponding to the discharge section D to be inspected is input to the detection circuit 33 through the supply switching circuit 31. The detection circuit 33 acquires the input detection potential signal VX, generates the detection signal SK according to the acquired detection potential signal VX, and outputs the detection signal SK to the determination unit 7. The determination unit 7 determines whether or not the ink discharge state of the discharge section D to be inspected is normal based on the input detection signal SK, that is, whether or not the discharge section D to be inspected is in a normal discharge state. The determination unit 7 generates a state determination signal JH according to the determination result of the state of the discharge section D to be inspected, and outputs the state determination signal JH to the control unit 2. Accordingly, the control unit 2 can acquire the state of the discharge section D to be inspected and correct various signals to be output in accordance with the acquired state of the discharge section D to be inspected. As a result, quality of the image formed at the medium is improved.

Further, the control unit 2 outputs the maintenance control signal Ctrl-M for causing the maintenance unit 10 to execute maintenance processing. The maintenance unit 10 attempts to recover the state of the discharge section D in which the discharge abnormality occurs by executing the maintenance processing according to the input maintenance control signal Ctrl-M. Accordingly, the state of the discharge section D in which the discharge abnormality occurs can be recovered, and as a result, the quality of the image formed at the medium is improved.

As described above, the liquid discharge apparatus 1 of the present embodiment executes various types of processing including the discharge processing of forming an image on a medium in accordance with the image data signal IMG, the determination processing of determining the state of the discharge section D that discharges the ink to the medium, and the maintenance processing of attempting to recover the state of the discharge section D.

Although a case where the liquid discharge apparatus 1 has one head unit 3 is illustrated in FIG. 1, the liquid discharge apparatus 1 may have a plurality of head units 3. At this time, the liquid discharge apparatus 1 may have the control unit 2, the sink unit 4, the drive circuit unit 5, and the determination unit 7 corresponding to each of the plurality of head units 3.

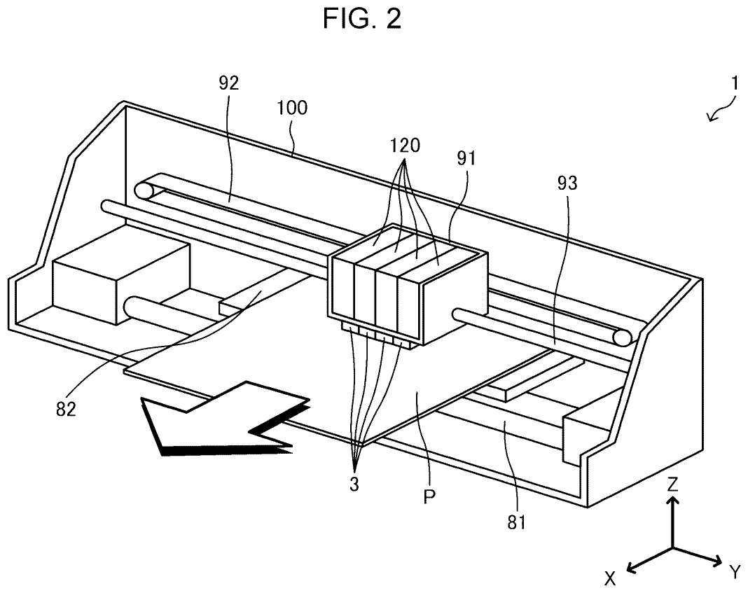

Next, an overview of the structure of the liquid discharge apparatus 1 will be described. FIG. 2 is a diagram illustrating an example of a schematic internal structure of the liquid discharge apparatus 1. As illustrated in FIG. 2, the liquid discharge apparatus 1 of the present embodiment is assumed to be a serial-type ink jet printer. That is, when the discharge processing is executed, the liquid discharge apparatus 1 discharges the ink from the head unit 3 while transporting a medium P such as the recording paper along a sub scanning direction and reciprocating a carriage 91 on which the head unit 3 is mounted along the main scanning direction intersecting the sub scanning direction. At this time, the ink discharged from the head unit 3 lands at a desired position on the medium P, and thus dots corresponding to the image data signal IMG are formed at the medium P. The liquid discharge apparatus 1 is not limited to the serial-type ink jet printer, and may be a line-type ink jet printer.

In the following description, an X-axis, a Y-axis, and a Z-axis that are orthogonal to each other are used. In addition, in the following description, a starting point side of an arrow indicating a direction along the X-axis illustrated in the drawing may be referred to as a −X side, and a tip end side may be referred to as a +X side. A starting point side of an arrow indicating a direction along the Y-axis illustrated in the drawing may be referred to as a −Y side, and a tip end side may be referred to as a +Y side. A starting point side of an arrow indicating a direction along the Z-axis illustrated in the drawing may be referred to as a −Z side, and a tip end side may be referred to as a +Z side. As illustrated in FIG. 2, in the liquid discharge apparatus 1 of the present embodiment, the sub scanning direction is located along the X-axis, the main scanning direction is located along the Y-axis, the medium P is transported along the X-axis such that the −X side is upstream and the +X side is downstream, and the carriage 91 is provided to reciprocate along the Y-axis.

As illustrated in FIG. 2, the liquid discharge apparatus 1 includes a housing 100 and a carriage 91 that is configured to reciprocate in the housing 100 in a Y-axis direction and on which one or the plurality of head units 3 are mounted. Four ink cartridges 120, which correspond one-to-one to the four inks of cyan, magenta, yellow, and black, are mounted on the carriage 91. At this time, in the liquid discharge apparatus 1 of the present embodiment, it is assumed, as one example, that four head units 3 are provided, the four head units 3 corresponding one-to-one to four ink cartridges 120.

Ink is supplied from the corresponding ink cartridge 120 to the M discharge sections D included in each of four head units 3. As a result, the ink supplied from the corresponding ink cartridge 120 is filled into the total of 4M discharge sections D included in each of the four head units 3. Then, each of the total of 4M discharge sections D included in each of the four head units 3 discharges the filled ink toward the medium P. The ink cartridge 120 may not be mounted on the carriage 91 and may be provided outside the carriage 91.

In addition, the liquid discharge apparatus 1 of the present embodiment includes, as the carriage movement unit 9 described above, a carriage transport mechanism 92 for reciprocating the carriage 91 along the Y-axis, and a carriage guide shaft 93 that supports the carriage 91 to reciprocate in the direction along the Y-axis and also includes a medium transport mechanism 81 for transporting the medium P and a platen 82 provided on the −Z side of the carriage 91, as the transport unit 8. When the discharge processing is executed, the carriage 91 on which the head unit 3 is mounted reciprocates along the Y-axis by the carriage transport mechanism 92 along the carriage guide shaft 93, and the medium P is transported from the −X side to the +X side on the platen 82 along the X-axis by the medium transport mechanism 81. As a result, a relative position of the medium P with respect to the head unit 3 is changed, and the ink can land on the entire medium P.

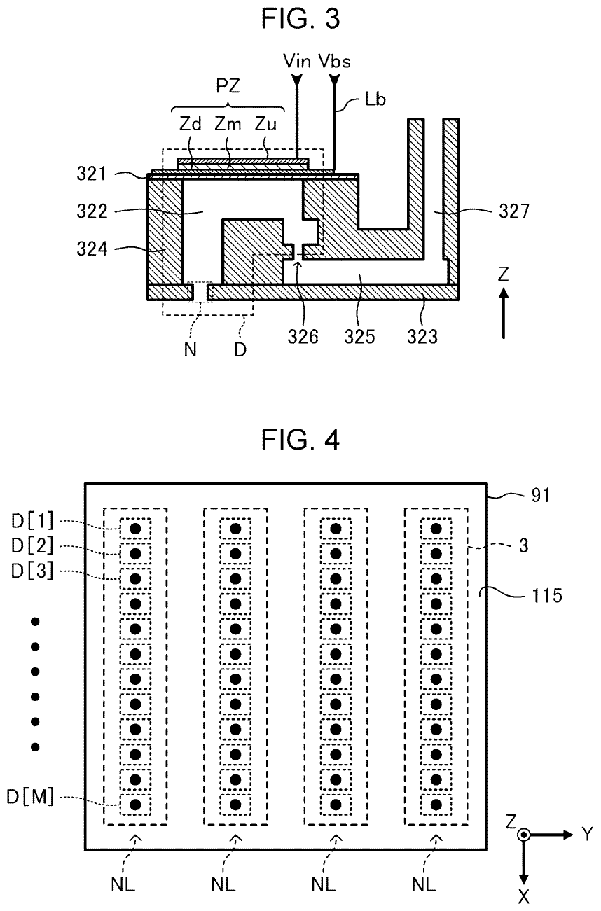

Here, an example of a structure of one of the plurality of discharge sections D that discharge the ink to the medium P will be described. FIG. 3 is a diagram illustrating a schematic structure of the discharge section D. As illustrated in FIG. 3, the discharge section D includes a piezoelectric element PZ, a cavity 322 filled with ink therein, a nozzle N communicating with the cavity 322, and a diaphragm 321. Then, the discharge section D drives the piezoelectric element PZ by supplying the supply drive signal VIN to the piezoelectric element PZ, and discharges the ink stored inside the cavity 322 from the nozzle N by driving the piezoelectric element PZ.

The cavity 322 is a space defined by a cavity plate 324, a nozzle plate 323 in which the nozzle N is formed, and the diaphragm 321. The cavity 322 communicates with a reservoir 325 via an ink supply port 326, and the reservoir 325 communicates with the ink cartridge 120 corresponding to the discharge section D via an ink intake port 327. Accordingly, the ink is supplied from the corresponding ink cartridge 120 to the inside of the cavity 322 via the ink intake port 327, the reservoir 325, and the ink supply port 326. Therefore, the ink supplied from the corresponding ink cartridge 120 is filled into the cavity 322.

The piezoelectric element PZ has an upper electrode Zu, a lower electrode Zd, and a piezoelectric body Zm. The piezoelectric body Zm is located between the upper electrode Zu and the lower electrode Zd. The supply drive signal VIN output from the supply switching circuit 31 is supplied to the upper electrode Zu. In addition, the reference voltage signal VBS propagating through a wiring Lb is supplied to the lower electrode Zd. The piezoelectric body Zm has a potential difference between the upper electrode Zu and the lower electrode Zd, and is displaced on the +Z side or the −Z side along the Z-axis according to a potential difference between a voltage value of the supply drive signal VIN supplied to the upper electrode Zu and a voltage value of the reference voltage signal VBS supplied to the lower electrode Zd. That is, the piezoelectric element PZ is driven to be displaced along the Z-axis to the +Z side or the −Z side according to a potential difference between a voltage value of the supply drive signal VIN and a voltage value of the reference voltage signal VBS. Here, the reference voltage signal VBS supplied to the lower electrode Zd is a signal that is a reference potential for driving the piezoelectric element PZ, and is a signal having a constant potential such as 5.5 V, 6 V, or a ground potential.

The lower electrode Zd is joined to the diaphragm 321. Therefore, when the piezoelectric element PZ is driven to be displaced along the Z-axis by the supply drive signal VIN, the diaphragm 321 is also displaced along the Z-axis. An internal volume and an internal pressure of the cavity 322 change due to the displacement of the diaphragm 321. Then, the ink filled inside the cavity 322 is discharged from the nozzle N in response to the change in the internal volume and the internal pressure of the cavity 322. That is, an amount of ink corresponding to the drive amount of the piezoelectric element PZ is discharged from the nozzle N of the discharge section D. In other words, the piezoelectric element PZ discharges the amount of ink corresponding to the displacement caused by the supply of the supply drive signal VIN corresponding to the drive signal COM from the discharge section D. That is, the discharge section D includes the piezoelectric element PZ driven by the drive signal COM and discharges the ink by driving the piezoelectric element PZ. In other words, the liquid discharge apparatus 1 includes the discharge section D that discharges ink, which is an example of a liquid.

FIG. 4 is a diagram illustrating an example of an arrangement of the total of 4M discharge sections D provided in the four head units 3 and 4M nozzles N included in the 4M discharge sections D. As illustrated in FIG. 4, the four head units 3 are located side by side along the Y-axis in the carriage 91. At this time, the M discharge sections D and the nozzles N of each of the four head units 3 are provided to be located side by side along the X-axis. Specifically, the discharge sections D[1] to D[M], which are the M discharge sections D included in the head unit 3, are located adjacent to each other in the order of the discharge section D[1], the discharge section D[2], the discharge section D[3], . . . , and the discharge section D[M] from the −X side to the +X side along the X-axis. That is, the head unit 3 includes a nozzle row NL formed by arranging the M nozzles N included in each of the M discharge sections D from the −X side to the +X side along the X-axis. Therefore, nozzle rows NL included in each of the four head units 3 are formed in four rows along the Y-axis in the carriage 91. Ink is discharged from each of the nozzles N forming the nozzle row NL included in each of the four head units 3. Here, in the following description, a surface on which a plurality of nozzle rows NL are formed by the plurality of head units 3 mounted on the carriage 91, which is located to face the medium P and from which the ink is discharged toward the medium P, may be referred to as a discharge surface 115.

That is, the liquid discharge apparatus 1 of the present embodiment includes the recording head 32 including the plurality of discharge sections D including the discharge section D[1] that discharges ink by driving a piezoelectric element PZ[1] and the discharge section D[m] that discharges ink by driving a piezoelectric element PZ[m], and the head unit 3.

### 2. Configuration and Operation of Drive Circuit

Next, a configuration and an operation of the drive circuit 50 included in the drive circuit unit 5 will be described. As described above, the drive circuit 50 generates and outputs a drive signal COM by amplifying a signal waveform defined by the drive waveform designation signal dCOM.

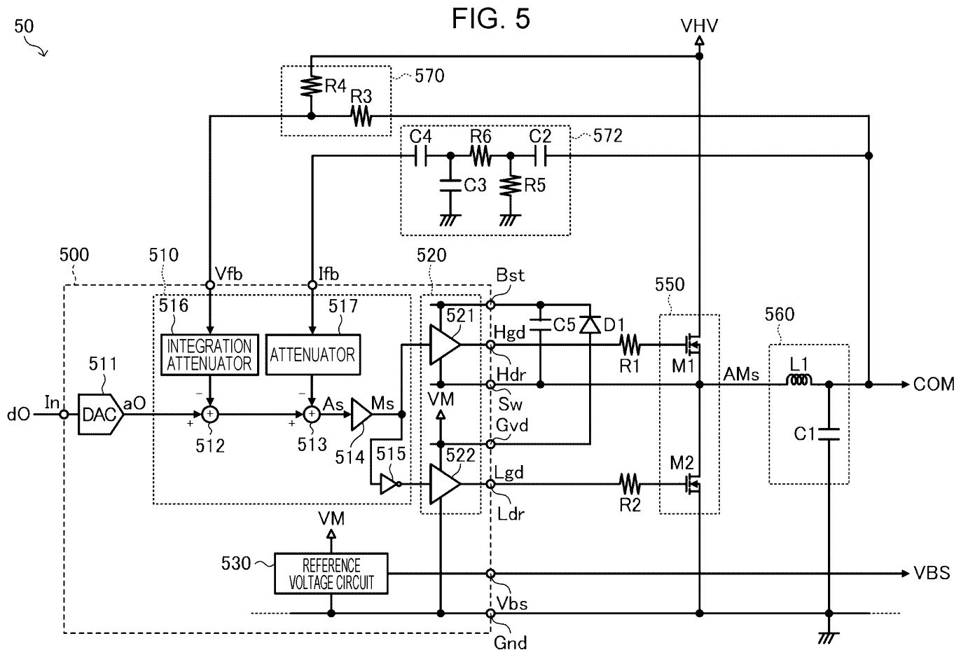

FIG. 5 is a diagram illustrating an example of a configuration of the drive circuit 50. As illustrated in FIG. 5, the drive circuit 50 includes an integrated circuit 500, an amplifier circuit 550, a demodulation circuit 560, feedback circuits 570 and 572, and a plurality of other circuit elements. The integrated circuit 500 generates a gate signal Hgd and a gate signal Lgd based on the drive waveform designation signal dCOM and outputs the signals to the amplifier circuit 550. The amplifier circuit 550 has transistors M1 and M2, and the transistors M1 and M2 are driven based on the gate signals Hgd and Lgd, whereby an amplified modulation signal AMs is generated and output to the demodulation circuit 560. The demodulation circuit 560 demodulates the amplified modulation signal AMs by smoothing the amplified modulation signal AMs. The signal demodulated by the demodulation circuit 560 is output from the drive circuit 50 and the drive circuit unit 5 as the drive signal COM.

The integrated circuit 500 includes a plurality of terminals including a terminal In, a terminal Bst, a terminal Hdr, a terminal Sw, a terminal Gvd, a terminal Ldr, a terminal Gnd, a terminal Ifb, a terminal Vfb, and a terminal Vbs. The integrated circuit 500 is electrically coupled to an external circuit via the plurality of terminals. The integrated circuit 500 includes a digital to analog converter (DAC) 511, a modulation circuit 510, and a gate drive circuit 520.

The DAC 511 converts the drive waveform designation signal dCOM, which is a digital signal that defines the signal waveform of the drive signal COM, into a base drive waveform signal aO, which is an analog signal, and outputs the base drive waveform signal aO to the modulation circuit 510. A signal obtained by amplifying the base drive waveform signal aO output by the DAC 511 corresponds to the drive signal COM. That is, the base drive waveform signal aO is an analog signal that is a target signal before amplification of the drive signal COM, the drive waveform designation signal dCOM is a digital signal that is a target signal before amplification of the drive signal COM, and is a digital signal that defines the shape of the signal waveform of the drive signal COM. The voltage amplitude of the base drive waveform signal al output by the DAC 511 is set to, for example, 1 V to 2 V.

The modulation circuit 510 modulates the base drive waveform signal aO, thereby generating a modulation signal Ms and outputting the modulation signal Ms to the gate drive circuit 520. The modulation circuit 510 includes adders 512 and 513, a comparator 514, an inverter 515, an integration attenuator 516, and an attenuator 517.

The integration attenuator 516 attenuates and integrates the voltage value of the drive signal COM input via the terminal Vfb, and outputs the integrated signal to an input terminal on the −side of the adder 512. The base drive waveform signal aO is input to an input terminal on the +side of the adder 512. The adder 512 generates a signal having a voltage value obtained by subtracting the voltage value of the signal input to the input terminal on the −side from the voltage value of the signal input to the input terminal on the +side and by integrating the results, and outputs the signal to an input terminal on the +side of the adder 513. Here, the maximum value of the voltage amplitude of the base drive waveform signal aO is approximately 2 V as described above, but the maximum value of the voltage value of the drive signal COM may exceed 40 V. In obtaining the deviation, the integration attenuator 516 attenuates the drive signal COM input via the terminal Vfb in order to match a range of the voltage amplitude of the base drive waveform signal aO and a range of the voltage value amplitude of the drive signal COM.

The attenuator 517 supplies a voltage obtained by attenuating the high frequency component of the drive signal COM input via the terminal Ifb to the input terminal on the −side of the adder 513. A signal output from the adder 512 is input to an input terminal on the +side of the adder 513. The adder 513 generates a voltage signal As by subtracting the voltage value of a signal input to the input terminal on the −side from the voltage value of the signal input to the input terminal on the +side, and outputs the voltage signal As to the comparator 514. The voltage signal As is a signal obtained by subtracting the voltage value of the signal supplied to the terminal Vfb from the voltage value of the base drive waveform signal aO and further subtracting the voltage value of the signal supplied to the terminal Ifb. Therefore, the voltage signal As becomes a signal obtained by correcting the deviation, which is obtained by subtracting the attenuation voltage of the drive signal COM from the voltage value of the target base drive waveform signal aO, with the high frequency component of the drive signal COM.

The comparator 514 pulse-modulates the voltage signal As, and outputs the modulated voltage signal As as the modulation signal Ms. Specifically, the comparator 514 outputs the modulation signal Ms that becomes an H level when the voltage value of the voltage signal As is equal to or higher than a predetermined threshold value Vth1 in a period in which the voltage value of the voltage signal As is increasing, and becomes a L level when the voltage value of the voltage signal As falls below a predetermined threshold value Vth2 in a period in which the voltage value of the voltage signal As is decreasing. Here, the threshold values Vth1 and Vth2 are set to threshold value Vth1>threshold value Vth2. The frequency and the duty ratio of the modulation signal Ms change in accordance with the drive waveform designation signal dCOM and the base drive waveform signal aO. That is, the amount of change in the frequency and duty ratio of the modulation signal Ms can be adjusted by adjusting a modulation gain that corresponds to the sensitivity of the attenuator 517.

The modulation signal Ms is input to a gate driver 521 included in the gate drive circuit 520. In addition, the modulation signal Ms is also input to the gate driver 522 included in the gate drive circuit 520 after the logic level is inverted by the inverter 515. That is, signals having logic levels in a mutually exclusive relationship are input to the gate driver 521 and the gate driver 522.

Here, timing of signals input to the gate drivers 521 and 522 may be controlled such that logic levels do not simultaneously become the H level. That is, the above-described “logic levels in a mutually exclusive relationship” means that when the logic level of the signal input to the gate driver 521 and the logic level of the signal input to the gate driver 522 are not required to be at the H level at the same time, and when the logic level of the signal input to the gate driver 521 and the logic level of the signal input to the gate driver 522 simultaneously become the L level, such cases are included.

The gate drive circuit 520 includes the gate driver 521 and the gate driver 522.

The gate driver 521 level-shifts the modulation signal Ms output by the comparator 514, thereby generating the gate signal Hgd and outputting the gate signal Hgd from the integrated circuit 500 via the terminal Hdr. Within the power supply voltages of the gate driver 521, a high potential side is supplied via the terminal Bst, and a low potential side is supplied via the terminal Sw. The terminal Bst is electrically coupled to one end of a capacitor C5 and a cathode of a diode D1. The other end of the capacitor C5 is electrically coupled to the terminal Sw. An anode of the diode D1 is electrically coupled to the terminal Gvd. In addition, the terminal Gvd is supplied with a voltage signal VM, which is a DC voltage of, for example, 7.5 V generated by a power supply circuit (not illustrated). As a result, a potential difference between the terminal Bst and the terminal Sw is the potential difference between both ends of the capacitor C5, and becomes approximately equal to the voltage value of the voltage signal VM. Therefore, the gate driver 521 generates the gate signal Hgd in which the voltage value of the H level is larger than the voltage value of the terminal Sw by the voltage value of the voltage signal VM, and the voltage value of the L level becomes the voltage value of the terminal Sw, according to the logic level of the input modulation signal Ms, and outputs the gate signal Hgd from the terminal Hdr.

The gate driver 522 operates on the lower potential side than the gate driver 521. The gate driver 522 generates the gate signal Lgd by level-shifting a signal in which the logic level of the modulation signal Ms output by the comparator 514 is inverted by the inverter 515, and outputs the gate signal Lgd from the integrated circuit 500 via the terminal Ldr. Within the power supply voltages of the gate driver 522, the voltage signal VM is supplied to the high potential side, and a ground potential is supplied to the low potential side via the terminal Gnd. In addition, according to the logic level of the input signal, the gate driver 522 generates a gate signal Lgd having the H level voltage value that is greater than the voltage value of the terminal Gnd by a voltage value of the voltage signal VM, and the L level voltage value that is the voltage value of the terminal Gnd at a ground potential, and outputs the gate signal Lgd from the terminal Ldr.

Here, as described above, the gate signal Hgd is a signal obtained by level-shifting a voltage value of the modulation signal Ms, and the gate signal Lgd is a signal obtained by inverting the logic level of the modulation signal Ms and then level-shifting the voltage value of the inverted signal. In view of such a point, the gate signal Hgd and the gate signal Lgd output by the gate drive circuit 520 can also be regarded as signals obtained by modulating the drive waveform designation signal dCOM and the base drive waveform signal aO.

The amplifier circuit 550 includes a transistor pair including the transistors M1 and M2 which are semiconductor elements such as N-type field-effect transistors (FET).

A voltage signal VHV, which is, for example, a DC voltage of 42 V, is supplied to a drain terminal of the transistor M1. In addition, the voltage value of the voltage signal VHV may be greater than the maximum voltage value of the drive signal COM output by the drive circuit 50 and the drive circuit unit 5, and is not limited to 42 V. The gate terminal of the transistor M1 is electrically coupled to one end of a resistor R1. The other end of the resistor R1 is electrically coupled to the terminal Hdr of the integrated circuit 500. That is, the gate signal Hgd output by the integrated circuit 500 is input to the gate terminal of the transistor M1. A source terminal of the transistor M1 is electrically coupled to the terminal Sw of the integrated circuit 500. In addition, in the transistor M1, a conductive state between the drain terminal and the source terminal is controlled by the gate signal Hgd to be input to the gate terminal.

A drain terminal of the transistor M2 is electrically coupled to the terminal Sw of the integrated circuit 500. That is, the drain terminal of the transistor M2 and the source terminal of the transistor M1 are electrically coupled to each other. The gate terminal of the transistor M2 is electrically coupled to one end of a resistor R2. The other end of the resistor R2 is electrically coupled to the terminal Ldr of the integrated circuit 500. That is, the gate signal Lgd output by the integrated circuit 500 is input to the gate terminal of the transistor M2. A ground potential is supplied to the source terminal of the transistor M2. In the transistor M2, the conductive state between the drain terminal and the source terminal is controlled by the gate signal Lgd to be input to the gate terminal.

Here, in the following description, a case where the drain terminal and the source terminal of the transistors M1 and M2 are controlled to be conductive may be referred to as on, and a case where the drain terminal and the source terminal of the transistors M1 and M2 are controlled to be non-conductive may be referred to as off.

In the amplifier circuit 550 configured as described above, when the transistor M1 is controlled to be off and the transistor M2 is controlled to be on, a node to which the terminal Sw is coupled becomes a ground potential. At this time, the voltage signal VM is supplied to the terminal Bst. On the other hand, when the transistor M1 is controlled to be on and the transistor M2 is controlled to be off, the node to which the terminal Sw is coupled becomes the voltage signal VHV. Therefore, a signal having a voltage value that is the sum of the voltage value of the voltage signal VHV and the voltage value of the voltage signal VM is supplied to the terminal Bst. That is, the gate driver 521 that drives the transistor M1 uses the capacitor C5 as a floating power supply, and the potential of the terminal Sw at the other end of the capacitor C5 changes to the ground potential or the voltage value of the voltage signal VHV according to the operation of the transistor M1 and the transistor M2, whereby the gate driver 521 generates the gate signal Hgd in which the L level is the voltage value of the voltage signal VHV and the H level is the sum of the voltage value of the voltage signal VHV and the voltage value of the voltage signal VM, and supplies the gate signal Hgd to the gate terminal of the transistor M1.

On the other hand, the gate driver 522 that drives the transistor M2 generates a gate signal Lgd in which the L level is the ground potential and the H level is the voltage value of the voltage signal VM, regardless of operations of the transistor M1 and the transistor M2, and supplies the gate signal Lgd to the gate terminal of the transistor M2.

As described above, the amplifier circuit 550 amplifies the modulation signal Ms obtained by modulating the drive waveform designation signal dCOM and the base drive waveform signal aO based on the voltage signal VHV by the transistors M1 and M2 operating in response to the gate signals Hgd and Lgd. The amplifier circuit 550 outputs the amplified signal, as the amplified modulation signal AMs, from a coupling point where the source terminal of the transistor M1 and the drain terminal of the transistor M2 are commonly coupled.

The demodulation circuit 560 demodulates the amplified modulation signal AMs by smoothing, and thereby generates the drive signal COM. The demodulation circuit 560 outputs the generated drive signal COM from the drive circuit 50.

The demodulation circuit 560 includes a coil L1 and a capacitor C1. One end of the coil L1 is electrically coupled to the source terminal of the transistor M1 and the drain terminal of the transistor M2. As a result, the amplified modulation signal AMs is input to the one end of the coil L1. Further, the other end of the coil L1 is also coupled to one end of the capacitor C1. The ground potential is supplied to the other end of the capacitor C1. That is, the coil L1 and the capacitor C1 configure a low pass filter. The amplified modulation signal AMs is smoothed by the low pass filter configured in the demodulation circuit 560, and thus the drive signal COM is generated at a coupling point where the other end of the coil L1 and the one end of the capacitor C1 are electrically coupled to each other.

The feedback circuit 570 includes a resistor R3 and a resistor R4. The drive signal COM is supplied to one end of the resistor R3, and the other end of the resistor R3 is coupled to the terminal Vfb and one end of the resistor R4. The voltage signal VHV is supplied to the other end of the resistor R4. As a result, the drive signal COM that has passed through the feedback circuit 570 is fed back to the terminal Vfb in a pulled-up state.

The feedback circuit 572 includes capacitors C2, C3, and C4 and resistors R5 and R6. The drive signal COM is supplied to one end of the capacitor C2, and the other end of the capacitor C2 is coupled to one end of the resistor R5 and one end of the resistor R6. The ground potential is supplied to the other end of the resistor R5. Accordingly, the capacitor C2 and the resistor R5 function as a high pass filter.

In addition, the other end of the resistor R6 is coupled to one end of the capacitor C4 and one end of the capacitor C3. The ground potential is supplied to the other end of the capacitor C3. Accordingly, the resistor R6 and the capacitor C3 function as a low pass filter.

As described above, the feedback circuit 572 includes the high pass filter and the low pass filter. Accordingly, the feedback circuit 572 functions as a band pass filter that passes the drive signal COM through a predetermined frequency range. The other end of the capacitor C4 included in the feedback circuit 572 is coupled to the terminal Ifb of the integrated circuit 500. Accordingly, a signal in which a DC component is cut, among high frequency components of the drive signal COM passing through the feedback circuit 572, is fed back to the terminal Ifb, the feedback circuit 572 functioning as a band pass filter that allows predetermined frequency components to pass.

As described above, the drive signal COM output from the drive circuit 50 is a signal obtained by demodulating, with the demodulation circuit 560, the amplified modulation signal AMs based on the drive waveform designation signal dCOM by smoothing. The drive signal COM output by the demodulation circuit 560 is integrated and attenuated via the feedback circuit 570 and the terminal Vfb, and then fed back to the adder 512. Accordingly, the drive circuit 50 self-oscillates at a frequency determined by a feedback delay and a feedback transfer function. However, with only the feedback path via the terminal Vfb, the delay amount is large, and therefore it may not be possible to increase a frequency of self-oscillation to such an extent that accuracy of the drive signal COM can be sufficiently ensured.

The drive circuit 50 of the present embodiment has a path, separately from the path via the terminal Vfb, for feeding back the high frequency component of the drive signal COM via the feedback circuit 572 and the terminal Ifb. As a result, in the drive circuit 50 of the present embodiment, the delay when the entire circuit is viewed can be reduced, and the frequency of the voltage signal As can be made high enough to sufficiently ensure the accuracy of the drive signal COM, as compared with the frequency when the path via the terminal Ifb does not exist. As a result, waveform accuracy of the drive signal COM is improved.

That is, the drive circuit 50 includes a class D amplifier circuit and outputs the drive signal COM supplied to an upper electrode Zu[1] which is one end of the piezoelectric element PZ[1] and an upper electrode Zu[m] which is one end of the piezoelectric element PZ[m].

In addition, as illustrated in FIG. 5, the integrated circuit 500 of the drive circuit 50 includes a reference voltage circuit 530. The reference voltage circuit 530 generates the reference voltage signal VBS by lowering the voltage value of the voltage signal VM, and outputs the reference voltage signal VBS from the drive circuit 50 and the drive circuit unit 5 via the terminal Vbs of the integrated circuit 500.

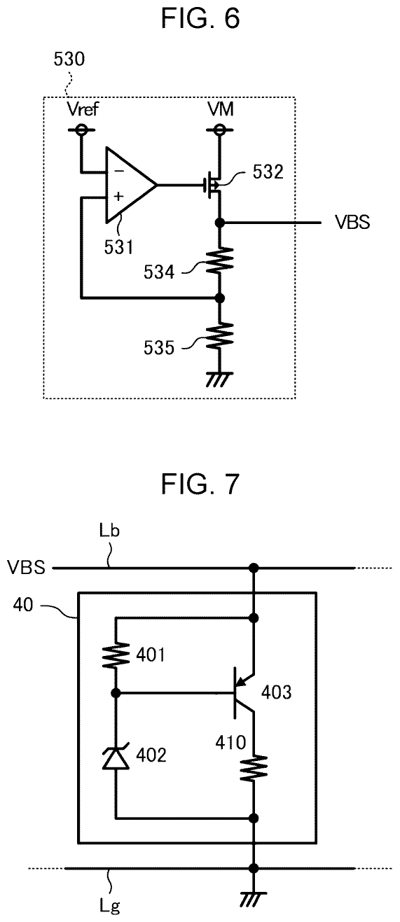

FIG. 6 is a diagram illustrating an example of a configuration of the reference voltage circuit 530. The reference voltage circuit 530 includes a comparator 531, a transistor 532, and resistors 534 and 535. Description will be made on the assumption that the transistor 532 is a PMOS transistor.

A reference voltage Vref is supplied to a −side input terminal of the comparator 531. The reference voltage Vref can be generated, for example, based on a bandgap reference voltage of the integrated circuit 500. In addition, +side input terminal of the comparator 531 is electrically coupled to one end of the resistor 534 and one end of the resistor 535. An output terminal of the comparator 531 is electrically coupled to a gate terminal of the transistor 532. The voltage signal VM is supplied to a source terminal of the transistor 532. A drain terminal of the transistor 532 is electrically coupled to the other end of the resistor 534. Further, a ground potential is supplied to the other end of the resistor 535. The reference voltage circuit 530 outputs a reference voltage signal VBS from a coupling point where the drain terminal of the transistor 532 and the other end of the resistor 534 are electrically coupled to each other.

In the reference voltage circuit 530 configured as described above, when a voltage value supplied to the +side input terminal of the comparator 531 is greater than a voltage value of the reference voltage Vref supplied to the −side input terminal of the comparator 531, the comparator 531 outputs a signal of an H level. At this time, the transistor 532 is controlled to be turned off. Therefore, the voltage signal VM is not supplied to the coupling point where the drain terminal of the transistor 532 and the other end of the resistor 534 are electrically coupled to each other. Meanwhile, when the voltage value supplied to the −side input terminal of the comparator 531 is less than the voltage value of the reference voltage Vref supplied to the −side input terminal of the comparator 531, the comparator 531 outputs a signal of an L level. At this time, the transistor 532 is controlled to be turned on. Therefore, the voltage signal VM is supplied to the coupling point where the drain terminal of the transistor 532 and the other end of the resistor 534 are electrically coupled to each other.

That is, in the reference voltage circuit 530, the comparator 531 and the transistor 532 operate such that a voltage value obtained by dividing the voltage value of the reference voltage signal VBS, which is a voltage value at the coupling point where the drain terminal of the transistor 532 and the other end of the resistor 534 are electrically coupled to each other, by the resistors 534 and 535 is equal to a voltage value of the reference voltage Vref. Therefore, the reference voltage circuit 530 generates and outputs the reference voltage signal VBS having a constant voltage value. In other words, the reference voltage circuit 530 generates the reference voltage signal VBS having a constant voltage value by lowering the voltage value of the voltage signal VM, and outputs the reference voltage signal VBS from the drive circuit 50 and the drive circuit unit 5 via the terminal Vbs of the integrated circuit 500.

That is, the drive circuit unit 5 includes the reference voltage circuit 530 that outputs the reference voltage signal VBS supplied to the lower electrode Zd[1], which is the other end of the piezoelectric element PZ[1], and the lower electrode Zd[m], which is the other end of the piezoelectric element PZ[m].

The reference voltage circuit 530 may be configured separately from the drive circuit unit 5, and in this case, a part of all of circuit elements constituting the reference voltage circuit 530 may be configured as discrete components outside the integrated circuit 500. However, as illustrated in FIG. 5, it is preferable that all circuit elements constituting the reference voltage circuit 530 are configured inside the integrated circuit 500. As a result, the size reduction of the drive circuit unit 5 including the drive circuit 50 and the reference voltage circuit 530, and the liquid discharge apparatus 1 including the drive circuit unit 5 can be realized.

### 3. Configuration and Operation of Sink Circuit

Next, a configuration and an operation of the sink circuit 40 included in the sink unit 4 will be described. FIG. 7 is a diagram illustrating an example of a configuration of the sink circuit 40. As described above, the sink circuit 40 releases the charge of the wiring Lb through which the reference voltage signal VBS propagates to the wiring Lg through which the ground potential propagates, according to a voltage value of the reference voltage signal VBS.

When a short-circuit abnormality occurs in some of the piezoelectric elements PZ[1] to PZ[M] included in each of the discharge sections D[1] to D[M], for example, in the piezoelectric element PZ[m], the amount of current flowing into the wiring Lb via the piezoelectric element PZ[m] in which the short-circuit abnormality occurs increases. Thus, as the amount of current propagating through the wiring Lb increases, the voltage value of the signal propagating through the wiring Lb, that is, the voltage value of the reference voltage signal VBS increases. After that, when the voltage value exceeds a predetermined detection threshold value at which an overvoltage protection function (not illustrated) of the liquid discharge apparatus 1 operates, the liquid discharge apparatus 1 stops the operation.

On the other hand, when the ink is not discharged from the discharge section D[m], the liquid discharge apparatus 1 has a so-called complementary function of complementing dots that can be formed at the medium P by the ink discharged from the discharge section D[m] originally, with the dots formed by the ink discharged from at least one of the discharge section D[m+1] and the discharge section D[m−1] located adjacent to the discharge section D[m]. In the liquid discharge apparatus 1 having such a complementary function, when the liquid discharge apparatus 1 immediately stops the operation due to a short-circuit abnormality that occurs in a small number of piezoelectric elements PZ among the piezoelectric elements PZ[1] to PZ[M], even though an image can be formed at the medium P in accordance with the image data signal IMG, the liquid discharge apparatus 1 stops the operation, and as a result, there is a possibility that the productivity of the liquid discharge apparatus 1 may decrease.

The sink circuit 40 has a sink function of releasing the charge of the wiring Lb to the wiring Lg through which the ground potential propagates when the voltage value of the signal propagating through the wiring Lb, that is, the voltage value of the reference voltage signal VBS exceeds the predetermined voltage value in response to the problem. As a result, the sink circuit 40 reduces the possibility that the voltage value of the signal propagating through the wiring Lb, that is, the voltage value of the reference voltage signal VBS increases, and reduces the risk that the operation of the liquid discharge apparatus 1 is stopped due to the short-circuit abnormality generated in the small number of piezoelectric elements PZ among the piezoelectric elements PZ[1] to PZ[M]. As a result, even when the short-circuit abnormality occurs in the small number of piezoelectric elements PZ[m] among the piezoelectric elements PZ[1] to PZ[M] included in each of the discharge sections D[1] to D[M], the possibility that the productivity of the liquid discharge apparatus 1 decreases can be reduced.

An example of the configuration and the operation of the sink circuit 40 will be described. FIG. 7 is a diagram illustrating an example of a configuration of the sink circuit 40. As illustrated in FIG. 7, the sink circuit 40 includes a resistor 401, a constant voltage diode 402, a transistor 403, and a resistor 410.

The transistor 403 is a PNP type bipolar transistor. An emitter terminal of the transistor 403 is electrically coupled to the wiring Lb through which the reference voltage signal VBS propagates. A collector terminal of the transistor 403 is electrically coupled to one end of the resistor 410. A base terminal of the transistor 403 is electrically coupled to the one end of the resistor 401 and a cathode terminal of the constant voltage diode 402. In addition, the other end of the resistor 401 is electrically coupled to the wiring Lb through which the reference voltage signal VBS propagates, an anode terminal of the constant voltage diode 402 and the other end of the resistor 410 are electrically coupled to the wiring Lg at the ground potential. That is, one end of the sink circuit 40 is electrically coupled to the wiring Lb through which the reference voltage signal VBS propagates and the other end thereof is electrically coupled to the wiring Lg at the ground potential.

In the sink circuit 40 configured as described above, when the voltage value of the reference voltage signal VBS propagating through the wiring Lb is smaller than a breakdown voltage vz of the constant voltage diode 402, a voltage value of the cathode terminal of the constant voltage diode 402 is held at the voltage value of the reference voltage signal VBS. Therefore, a voltage value of the emitter terminal of the transistor 403 and a voltage value of the base terminal are substantially the same. Therefore, when the voltage value of the reference voltage signal VBS propagating through the wiring Lb is smaller than the breakdown voltage vz of the constant voltage diode 402, the emitter terminal and the collector terminal of the transistor 403 are controlled to be non-conductive. At this time, the charge of the wiring Lb through which the reference voltage signal VBS propagates is not released to the wiring Lg through which the ground potential propagates. In other words, when the voltage value of the reference voltage signal VBS propagating through the wiring Lb is smaller than the breakdown voltage vz of the constant voltage diode 402, the sink circuit 40 does not release the charge of the wiring Lb.

On the other hand, when the voltage value of the reference voltage signal VBS propagating through the wiring Lb is greater than the breakdown voltage vz of the constant voltage diode 402, the voltage value of the cathode terminal of the constant voltage diode 402 is held at the breakdown voltage vz. Therefore, a potential difference corresponding to a difference between the voltage value of the reference voltage signal VBS and the breakdown voltage vz of the constant voltage diode 402 is generated between the emitter terminal of the transistor 403 and the base terminal of the transistor 403. When the potential difference is greater than a threshold voltage of the transistor 403, the emitter terminal and the collector terminal of the transistor 403 are controlled to be conductive. As a result, the charge of the wiring Lb through which the reference voltage signal VBS propagates is released toward the wiring Lg at the ground potential via the transistor 403 and the resistor 410. That is, at least a part of a current propagating through the wiring Lb flows toward the wiring Lg via the transistor 403 and the resistor 410. At this time, the amount of charge released from the wiring Lb to the wiring Lg and the amount of current flowing from the wiring Lb to the wiring Lg are controlled by a resistance value of the resistor 410. That is, a sink capacity of the sink circuit 40 is controlled by the resistance value of the resistor 410.

As described above, the sink circuit 40 of the present embodiment includes the transistor 403 and the resistor 410, the emitter terminal, which is one end of the transistor 403, is electrically coupled to the wiring Lb, the collector terminal, which is the other end of the transistor 403, is electrically coupled to one end of the resistor 410, and the other end of the resistor 410 is electrically coupled to the wiring Lg. Then, by controlling a conductive state of the transistor 403, the sink circuit 40 switches an impedance value between the wiring Lb through which the reference voltage signal VBS propagates and the wiring Lg through which a signal at the ground potential, which is a signal having a potential lower than the voltage value of the reference voltage signal VBS, propagates.

Accordingly, the sink circuit 40 releases the charge of the wiring Lb through which the reference voltage signal VBS propagates to the wiring Lg through which the ground potential propagates, according to a voltage value of the reference voltage signal VBS.

Such a sink circuit 40 is preferably configured with discrete components. As a result, the component sizes of the transistor 403 and the resistor 410 can be optimally selected according to the amount of current released from the wiring Lb by the sink circuit 40, that is, the sink capacity of the sink circuit 40, thereby enhancing the generality of the sink circuit 40 can be improved and reducing the amount of heat generation in the transistor 403 and the resistor 410.

Further, the sink circuit 40 may have a resistive element coupled between the anode terminal of the constant voltage diode 402 and the wiring Lg. As a result, the voltage value held by the cathode terminal of the constant voltage diode 402 and the amount of current flowing through the constant voltage diode 402 can be controlled, thereby enabling detailed control of the voltage value of the wiring Lb when the transistor 403 is controlled to be conductive.

In addition, although the sink circuit 40 can achieve the same effect as long as it is located between the wiring Lb through which the reference voltage signal VBS propagates and the wiring through which a signal having a potential lower than the voltage value of the reference voltage signal VBS propagates, as illustrated in the present embodiment, it is preferable that the sink circuit 40 is located between the wiring Lb through which the reference voltage signal VBS propagates and the wiring Lg at the ground potential. As a result, the sink circuit 40 can efficiently release charges from the wiring Lb.

### 4. Configuration of Head Unit

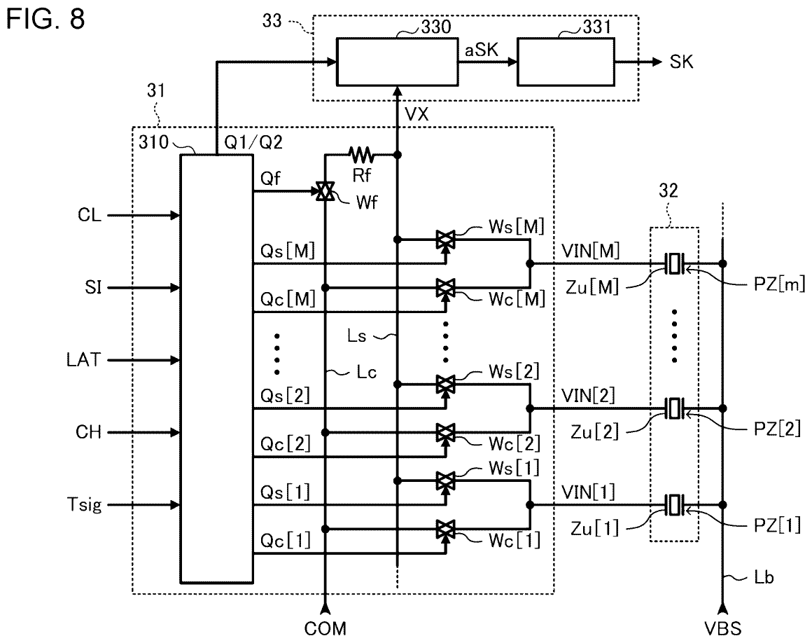

Next, a functional configuration of the head unit 3 will be described. FIG. 8 is a diagram illustrating an example of a functional configuration of the head unit 3. As described above, the head unit 3 includes the supply switching circuit 31, the recording head 32, and the detection circuit 33. In addition, in FIG. 8, a wiring Lc through which the drive signal COM propagates, the wiring Lb through which the reference voltage signal VBS propagates, and a wiring Ls through which the detection potential signal VX propagates to the detection circuit 33 are illustrated in the head unit 3.

The supply switching circuit 31 includes switches Wc[1] to Wc[M], switches Ws[1] to Ws[M], a switch Wf, a resistor Rf, and the coupling state designation circuit 310. The switches Wc[1] to Wc[M] and the switches Ws[1] to Ws[M] are provided corresponding to the discharge sections D[1] to D[M] in the supply switching circuit 31. Specifically, in the supply switching circuit 31, the switch Wc[m] and the switch Ws[m] are provided corresponding to the discharge section D[m].

The clock signal CL, the print data signal SI, the latch signal LAT, the change signal CH, and the period designation signal Tsig are input to the coupling state designation circuit 310. The coupling state designation circuit 310 generates a signal for designating a conductive state of each of the switches Wc[1] to Wc[M], the switches Ws[1] to Ws[M], and the switch Wf according to the print data signal SI propagated in synchronization with the clock signal CL in the period defined by the input latch signal LAT, the change signal CH, and the period designation signal Tsig. Thereafter, the coupling state designation circuit 310 outputs coupling state designation signals Qc[1] to Qc[M] by level-shifting the signals for designating the conductive states of the switches Wc[1] to Wc[M] to high amplitude logic signals, outputs coupling state designation signals Qs[1] to Qs[M] by level-shifting the signals for designating the conductive states of the switches Ws[1] to Ws[M] to high amplitude logic signals, and outputs a coupling state designation signal Of by level-shifting the signal for designating the conductive state of the switch Wf to a high amplitude logic signal.

The coupling state designation signals Qc[1] to Qc[M] output by the coupling state designation circuit 310 are input to control terminals of the switches Wc[1] to Wc[M], the coupling state designation signals Qs[1] to Qs[M] output by the coupling state designation circuit 310 are input to control terminals of the switches Ws[1] to Ws[M], and the coupling state designation signal Of output by the coupling state designation circuit 310 is input to a control terminal of the switch Wf. As a result, the conductive state of each of the switches Wc[1] to Wc[M], Ws[1] to Ws[M], and Wf are controlled.

The coupling state designation circuit 310 includes, for example, a register that holds the print data signal SI propagated in synchronization with the clock signal CL in correspondence with the discharge sections D[1] to D[M], a decoder that decodes the print data signal SI held in the register to generate a signal for designating the conductive state of the switches Wc[1] to Wc[M], Ws[1] to Ws[M], and Wf, and a level shift circuit that outputs the coupling state designation signals Qc[1] to Qc[M], Qs[1] to Qs[M], Of, and the like, obtained by level-shifting the logic of the signal generated by the decoder to the high amplitude logic signal.

Among the switches Wc[1] to Wc[M], a switch Wc[m] has one end electrically coupled to the wiring Lc and the other end electrically coupled to the upper electrode Zu[m] of the piezoelectric element PZ[m] included in the discharge section D[m]. The coupling state designation signal Qc[m] among the coupling state designation signals Qc[1] to Qc[M] is input to the control terminal of the switch Wc[m]. The switch Wc[m] switches the conductive state between one end and the other end according to the logic level of the coupling state designation signal Qc[m] input to the control terminal. As a result, the switch Wc[m] switches whether or not to supply the drive signal COM propagating through the wiring Lc to the upper electrode Zu[m] of the discharge section D[m] as the supply drive signal VIN[m] according to the coupling state designation signal Qc[m].

That is, the switch Wc[1] switches whether or not to supply the drive signal COM to the upper electrode Zu[1] which is the one end of the piezoelectric element PZ[1], and the switch Wc[m] switches whether or not to supply the drive signal COM to the upper electrode Zu[m] which is the one end of the piezoelectric element PZ[m].

One end of the switch Ws[m] among the switches Ws[1] to Ws[M] is electrically coupled to the wiring Ls, and the other end is electrically coupled to the upper electrode Zu[m] of the piezoelectric element PZ[m] included in the discharge section D[m]. The coupling state designation signal Qs[m] among the coupling state designation signals Qs[1] to Qs[M] is input to the control terminal of the switch Ws[m]. The switch Ws[m] switches the conductive state between one end and the other end according to the logic level of the coupling state designation signal Qs[m] input to the control terminal. As a result, the switch Ws[m] switches whether or not to supply the signal generated in the upper electrode Zu[m] of the piezoelectric element PZ[m] to the wiring Ls in response to the coupling state designation signal Qs[m] according to the residual vibration generated in the discharge section D[m].

That is, the switch Ws[1] switches whether or not to supply a signal corresponding to the residual vibration generated in the upper electrode Zu[1] which is one end of the piezoelectric element PZ[1] to the wiring Ls, and the switch Ws[m] switches whether or not to supply a signal corresponding to the residual vibration generated in the upper electrode Zu[m], which is one end of the piezoelectric element PZ[m] to the wiring Ls.

One end of the switch Wf is electrically coupled to the wiring Lc, and the other end thereof is electrically coupled to one end of the resistor Rf. Further, the other end of the resistor Rf is electrically coupled to the wiring Ls. That is, the one end of the switch Wf is electrically coupled to the wiring Lc, and the other end is electrically coupled to the wiring Ls via the resistor Rf. The coupling state designation signal Of is input to the control terminal of the switch Wf. The switch Wf switches the conductive state between one end and the other end according to the logic level of the coupling state designation signal Qf input to the control terminal.

Each of the switches Wc[1] to Wc[M], Ws[1] to Ws[M], and Wf as described above can be configured with, for example, a transmission gate.

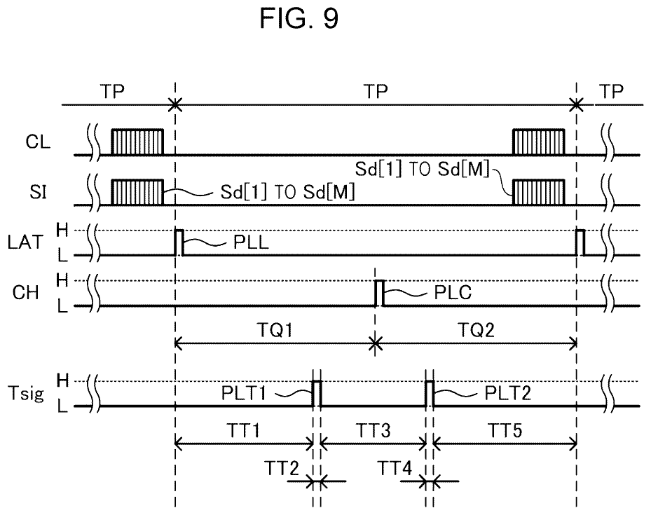

Here, an example of various signals input to the coupling state designation circuit 310 will be described. FIG. 9 is a diagram for explaining an example of various signals input to the coupling state designation circuit 310. As illustrated in FIG. 9, the liquid discharge apparatus 1 of the present embodiment defines one or a plurality of unit periods TP as an operation period, and controls the driving of the discharge section D[m] and the operation of the detection circuit 33 in each of the defined unit periods TP.

Specifically, the control unit 2 generates the latch signal LAT including a pulse PLL and outputs the latch signal LAT to the coupling state designation circuit 310. For example, the control unit 2 may generate the latch signal LAT including the pulse PLL at a timing based on at least one of the transport position of the medium P transported along the sub scanning direction and the scanning position of the carriage 91 reciprocating along the main scanning direction, by setting the logic level of the latch signal LAT to the H level for a short time, and may output the latch signal LAT to the coupling state designation circuit 310. Further, for example, the control unit 2 may generate the latch signal LAT including the pulse PLL by setting the logic level of the latch signal LAT to the H level for a short time at a predetermined time interval, and output the latch signal LAT to the coupling state designation circuit 310. The period from the rise of the pulse PLL included in the latch signal LAT to the next rise of the pulse PLL corresponds to the above-described unit period TP.

Further, the control unit 2 generates the change signal CH including a pulse PLC and outputs the change signal CH to the coupling state designation circuit 310. For example, the control unit 2 generates the change signal CH including the pulse PLC by setting the logic level of the change signal CH to the H level for a short time at a timing when a predetermined time has elapsed from the rise of the pulse PLL, and outputs the change signal CH to the coupling state designation circuit 310. The pulse PLC included in the change signal CH divides the unit period TP into a control period TQ1 and a control period TQ2. Specifically, the change signal CH divides the unit period TP into the control period TQ1, which is a period from the rise of the pulse PLL to the rise of the pulse PLC, and the control period TQ2, which is a period from the rise of the pulse PLC to the rise of the pulse PLL. The number of divisions of the unit period TP by the change signal CH is not limited to two.

The control unit 2 generates a period designation signal Tsig including pulses PLT1 and PLT2 and outputs the period designation signal Tsig to the coupling state designation circuit 310. For example, the control unit 2 generates the pulse PLT1 by setting the logic level of the period designation signal Tsig to the H level at a timing when a predetermined time has elapsed from the rise of the pulse PLL, and then setting the logic level of the period designation signal Tsig to the L level, and outputs the pulse PLT1 to the coupling state designation circuit 310. After generating the pulse PLT1, the control unit 2 generates the pulse PLT2 by setting the logic level of the period designation signal Tsig to the H level at a timing when a predetermined time has elapsed, and then setting the logic level of the period designation signal Tsig to the L level, and outputs the pulse PLT2 to the coupling state designation circuit 310. The pulses PLT1 and PLT2 included in the period designation signal Tsig divide the unit period TP into control periods TT1 to TT5. Specifically, the unit period TP is divided by the period designation signal Tsig into a control period TT1, which is a period from the rise of the pulse PLL to the rise of the pulse PLT1, a control period TT2, which is a period from the rise of the pulse PLT1 to the fall of the pulse PLT1, a control period TT3, which is a period from the fall of the pulse PLT1 to the rise of the pulse PLT2, a control period TT4, which is a period from the rise of the pulse PLT2 to the fall of the pulse PLT2, and a control period TT5, which is a period from the fall of the pulse PLT2 to the rise of the pulse PLL. The number of divisions of the unit period TP by the period designation signal Tsig is not limited to five.

Further, the control unit 2 generates the print data signal SI serially including individual designation signals Sd[1] to Sd[M] and outputs the print data signal SI to the coupling state designation circuit 310. The individual designation signals Sd[1] to Sd[M] are signals each including 2-bit information and define the driving mode of each of the discharge sections D[1] to D[M]. Here, in the following description, the 2-bit information included in the individual designation signal Sd[m] may be referred to as bits S1 and S2, and the individual designation signal Sd[m]=[S1, S2] may be expressed.

Specifically, the control unit 2 generates the print data signal SI including the individual designation signals Sd[1] to Sd[M] that define the driving mode of the discharge sections D[1] to D[M] in the unit period TP to be controlled and the operation of the detection circuit 33, prior to the unit period TP to be controlled, and outputs the print data signal SI to the coupling state designation circuit 310. The print data signal SI is held in a register (not illustrated) in the coupling state designation circuit 310 in a state in which the individual designation signals Sd[1] to Sd[M] correspond to the discharge sections D[1] to D[M], respectively. Then, when the unit period TP becomes a control target, the coupling state designation circuit 310 simultaneously latches 2-bit information included in each of the individual designation signals Sd[1] to Sd[M] held therein, and by decoding the latched 2-bit information, generates the coupling state designation signals Qc[1] to Qc[M], Qs[m] to Qs[M], Of, Q1, and Q2 having logic levels according to decoded contents in each of control periods TQ1 and TQ2 among the unit period TP to be controlled or in each of control periods TT1 to TT5, and outputs the coupling state designation signals to control terminals of corresponding switches Wc[1] to Wc[M], Ws[1] to Ws[M], Wf, W1, and W2.

As a result, the conductive state of each of the switches Wc[1] to Wc[M], Ws[1] to Ws[M], Wf, W1, and W2 in each of the control periods TQ1 and TQ2 or each of the control periods TT1 to TT5 are controlled. As a result, the driving mode of the discharge sections D[1] to D[M] and the operation of the detection circuit 33 in each of the control periods TQ1 and TQ2 or each of the control periods TT1 to TT5 is controlled.

Returning to FIG. 8, to the detection circuit 33, the detection potential signal VX propagating through the wiring Ls and the coupling state designation signals Q1 and Q2 output by the coupling state designation circuit 310 are input. Further, the detection circuit 33 includes a waveform shaping circuit 330 and an AD conversion circuit 331. The waveform shaping circuit 330 acquires a detection potential signal VX in accordance with the coupling state designation signals Q1 and Q2. The waveform shaping circuit 330 removes noise from the acquired detection potential signal VX and amplifies the detection potential signal VX to shape a signal waveform of the detection potential signal VX and output the shaped signal waveform as a detection signal aSK. The AD conversion circuit 331 converts the detection signal aSK, which is an analog signal output by the waveform shaping circuit 330, into a digital signal and outputs the digital signal as the detection signal SK. This detection signal SK is output from the detection circuit 33 and the head unit 3. That is, the detection circuit 33 changes the signal corresponding to the residual vibration generated in the discharge section D into the digital signal and outputs the digital signal as the detection signal SK.

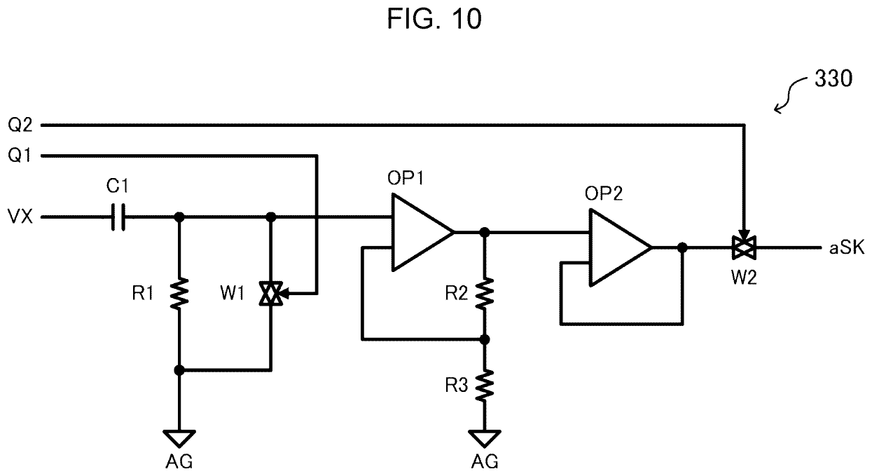

Here, an example of a configuration of the waveform shaping circuit 330 included in the detection circuit 33 will be described. FIG. 10 is a diagram illustrating an example of the configuration of the waveform shaping circuit 330. As illustrated in FIG. 10, the waveform shaping circuit 330 includes the capacitor C1, operational amplifiers OP1 and OP2, switches W1 and W2, and resistors R1 to R3.

The detection potential signal VX output by the supply switching circuit 31 is input to the one end of the capacitor C1. The other end of the capacitor C1 is electrically coupled to the one end of the resistor R1 and one end of the switch W1. An analog ground AG fixed to a constant potential is supplied to the other end of the resistor R1 and the other end of the switch W1. That is, the resistor R1 and the switch W1 are coupled in parallel. The coupling state designation signal Q1 is input to the control terminal of the switch W1. When the coupling state designation signal Q1 having an H level is input to the control terminal, the switch W1 becomes conductive between one end and the other end, and when the coupling state designation signal Q1 having an L level is input to the control terminal, the switch W1 becomes non-conductive between the one end and the other end. That is, the switch W1 switches the conductive state between the one end of the resistor R1 and the analog ground AG. The capacitor C1, the resistor R1, and the switch W1 configured as described above function as a high pass filter, and extract and output a signal of a predetermined high frequency component from the detection potential signal VX input in a period during which the switch W1 is controlled to be non-conductive. Here, the switch W1 may be configured with, for example, a transmission gate. Further, the analog ground AG may be, for example, a center potential between a power supply potential on a high potential side supplied to the head unit 3 and a power supply potential on a low potential side.

A +side input terminal of the operational amplifier OP1 is electrically coupled to a coupling point where the other end of the capacitor C1, the one end of the resistor R1, and the one end of the switch W1 are electrically coupled. That is, a signal output by the high pass filter including the capacitor C1, the resistor R1, and the switch W1 is input to the +side input terminal of the operational amplifier OP1. A −side input terminal of the operational amplifier OP1 is electrically coupled to a coupling point where the one end of the resistor R2 and the one end of the resistor R3 are electrically coupled. An output terminal of the operational amplifier OP1 is electrically coupled to the other end of the resistor R2. In addition, the analog ground AG is supplied to the other end of the resistor R3. That is, the operational amplifier OP1 and the resistors R2 and R3 function as a non-inverting amplifier circuit that amplifies a signal input to the +side input terminal of the operational amplifier OP1 according to resistance values of the resistors R2 and R3 and that outputs the signal from the output terminal of the operational amplifier OP1. Here, the non-inverting amplifier circuit including the operational amplifier OP1 and the resistors R2 and R3 may be configured to output an amplified signal after superimposing a predetermined offset voltage on a signal output from the high pass filter configured with the capacitor C1, the resistor R1, and the switch W1.

A +side input terminal of the operational amplifier OP2 is electrically coupled to the output terminal of the operational amplifier OP1. That is, a signal output by the non-inverting amplifier circuit configured with the operational amplifier OP1 and the resistors R2 and R3 is input to the +side input terminal of the operational amplifier OP2. A −side input terminal of the operational amplifier OP2 is electrically coupled to an output terminal of the operational amplifier OP2. That is, the operational amplifier OP2 constitutes a voltage follower circuit. Accordingly, the operational amplifier OP2 converts an impedance of the signal output from the non-inverting amplifier circuit configured with the operational amplifier OP1 and the resistors R2 and R3, and outputs the signal.

One end of the switch W2 is electrically coupled to the output terminal of the operational amplifier OP2. The signal at the other end of the switch W2 is output, as the detection signal aSK, from the waveform shaping circuit 330. In addition, the coupling state designation signal Q2 is input to the control terminal of the switch W2. When the coupling state designation signal Q2 having an H level is input to the control terminal, the switch W2 becomes conductive between one end and the other end, and when the coupling state designation signal Q2 having an L level is input to the control terminal, the switch W2 becomes non-conductive between the one end and the other end. The switch W2 switches whether or not to output the signal output by the operational amplifier OP2, as the detection signal aSK, from the waveform shaping circuit 330 according to the logic level of the coupling state designation signal Q2 input to the control terminal.

As described above, the waveform shaping circuit 330 removes noise components from the detection potential signal VX by the high pass filter including the capacitor C1, the resistor R1, and the switch W1, and amplifies the signal from which the noise component is removed by the non-inverting amplifier circuit including the operational amplifier OP1, and the resistors R2 and R3. The waveform shaping circuit 330 outputs the detection signal aSK after performing impedance conversion by a voltage follower circuit including the operational amplifier OP2. At this time, the switches W1 and W2 switch whether or not the waveform shaping circuit 330 acquires the detection potential signal VX and outputs it as a detection signal aSK.

Then, the detection signal aSK output by the waveform shaping circuit 330 is input to the AD conversion circuit 331. The AD conversion circuit 331 converts the detection signal aSK into a digital signal. The signal converted into digital by the AD conversion circuit 331 is output from the detection circuit 33 and the head unit 3 as the detection signal SK.

In the head unit 3 of the present embodiment configured as described above, the supply switching circuit 31 controls a conductive state of the switch Wc[m] according to the print data signal SI propagated based on the clock signal CL in each of control periods TQ1 and TQ2 or each of control periods TT1 to TT5 defined by the latch signal LAT, the change signal CH, and the period designation signal Tsig, thereby switching whether or not to supply the drive signal COM propagating through the wiring Lc, as a supply drive signal VIN[m], to the piezoelectric element PZ[m] of the discharge section D[m]. As a result, the driving mode of the discharge section D[m] is controlled.

In addition, in the head unit 3 of the present embodiment, the supply switching circuit 31 controls the conductive state of the switch Ws[m] according to the print data signal SI propagated based on the clock signal CL in each of the control periods TQ1 and TQ2 or each of the control periods TT1 to TT5 defined by the latch signal LAT, the change signal CH, and the period designation signal Tsig, thereby switching whether or not to acquire the signal according to the residual vibration generated in the discharge section D[m] and output the signal to the detection circuit 33 as the detection potential signal VX. At this time, the detection circuit 33 amplifies and shapes the signal waveform of the input detection potential signal VX according to the conductive states of the switches W1 and W2, and outputs the signal waveform as the detection signal SK. That is, when the piezoelectric element PZ is displaced in response to the residual vibration generated in the discharge section D, the detection circuit 33 acquires the electromotive force generated in the piezoelectric element PZ as the detection potential signal VX, amplifies and shapes the signal waveform of the acquired detection potential signal VX, and outputs the detection potential signal VX as the detection signal SK.

The detection signal SK output by the detection circuit 33 is input to the determination unit 7. The determination unit 7 determines a state of the target discharge section D[m] based on the input detection signal SK.

As described above, the liquid discharge apparatus 1 of the present embodiment includes the detection circuit 33 that detects a signal according to the states of the plurality of discharge sections D, and the determination unit 7 that determines the states of the plurality of discharge sections D based on the detection signal SK output by the detection circuit 33, and the determination unit 7 determines the state of the discharge section D[1] in response to the residual vibration generated in the discharge section D[1], and determines the state of the discharge section D[m] in response to the residual vibration generated in the discharge section D[m].

### 5. Operation of Liquid Discharge Apparatus

An operation of the liquid discharge apparatus 1 configured as described above will be described. As described above, the liquid discharge apparatus 1 of the present embodiment executes the discharge processing of discharging the ink to the medium P so as to form an image corresponding to the image data signal IMG, the determination processing of determining the state of the discharge section D that discharges the ink to the medium P, and the maintenance processing of attempting to recover the discharge state of the discharge section D in which the discharge abnormality occurs in the determination processing. In the following, the operation of each of the discharge processing, the determination processing, and the maintenance processing executed by the liquid discharge apparatus 1 will be described.

### 5.1 Discharge Processing

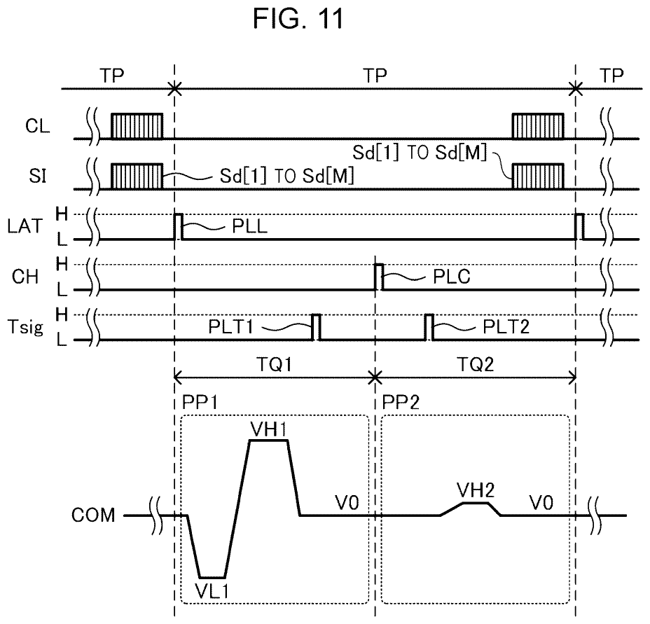

FIG. 11 is a diagram for explaining an example of various signals output by the control unit 2 in a period during which discharge processing is executed.

The control unit 2 generates a drive waveform designation signal dCOM that defines a signal waveform of the drive signal COM output by the drive circuit unit 5 in the period during which the discharge processing is executed, and outputs the drive waveform designation signal dCOM to the drive circuit unit 5. The drive circuit 50 included in the drive circuit unit 5 generates the drive signal COM having a signal waveform in which a drive waveform PP1 disposed in the control period TQ1 and the drive waveform PP2 disposed in the control period TQ2 are continuous for each unit period TP as illustrated in FIG. 11, according to the input drive waveform designation signal dCOM, and supplies the drive signal COM to the head unit 3.

The drive waveform PP1 is a signal waveform in which a voltage value starts at a reference potential V0, changes to a potential VL1 lower than the reference potential V0, then changes to a potential VH1 higher than the reference potential V0, and thereafter ends at the reference potential V0. When the drive waveform PP1 is supplied to the piezoelectric element PZ[m], the piezoelectric element PZ[m] is driven such that a predetermined amount of ink is discharged from the nozzle N[m]. That is, the drive waveform PP1 is the signal waveform for discharging the ink from the nozzle N[m].

The drive waveform PP2 is a signal waveform in which a voltage value starts at the reference potential V0, changes to a potential VH2 that is higher than the reference potential V0 and lower than the potential VH1, and thereafter ends at the reference potential V0. When the drive waveform PP2 is supplied to the piezoelectric element PZ[m], the ink in the vicinity of an opening portion vibrates to such an extent that the ink is not discharged from the nozzle N[m]. Accordingly, the possibility that the viscosity of the ink stored in the discharge section D[m] including the nozzle N[m] increases is reduced. Here, in the following description, an operation of supplying the drive waveform PP2 to the piezoelectric element PZ[m] and vibrating the ink in the vicinity of the opening portion of the nozzle N[m] is referred to as micro vibration. That is, the drive waveform PP2 is a signal waveform for performing the micro vibration.

Then, the liquid discharge apparatus 1 of the present embodiment selects, for each unit period TP in the period during which the discharge processing is executed, whether to supply the drive waveform PP1 to the discharge section D[m], to supply the drive waveform PP2 to the discharge section D[m], or to supply neither the drive waveform PP1 nor the drive waveform PP2 to the discharge section D[m]. Therefore, for each unit period TP in the period during which the discharge processing is executed, the liquid discharge apparatus 1 controls whether to discharge the ink from the discharge section D[m], not to discharge the ink from the discharge section D[m] and to execute the micro vibration, or not to discharge the ink from the discharge section D[m] and not to execute the micro vibration.

Specifically, in the period during which the liquid discharge apparatus 1 of the present embodiment executes the discharge processing, the coupling state designation circuit 310 defines the conductive state of the switch Wc[m] in each of the control periods TQ1 and TQ2 according to the individual designation signal Sd[m] included in the input print data signal SI. As a result, for each unit period TP in a period during which the liquid discharge apparatus 1 executes the discharge processing, it is controlled whether the drive waveform PP1 disposed in the control period TQ1 is supplied to the discharge section D[m] as the supply drive signal VIN[m], the drive waveform PP2 disposed in the control period TQ2 is supplied to the discharge section D[m] as the supply drive signal VIN[m], or neither the drive waveform PP1 disposed in the control period TQ1 nor the drive waveform PP2 disposed in the control period TQ2 is supplied to the discharge section D[m] as the supply drive signal VIN[m]. That is, for each unit period TP, it is controlled whether the ink is discharged from the discharge section D[m], the ink is not discharged from the discharge section D[m] and the micro vibration is executed, or the ink is not discharged from the discharge section D[m] and the micro vibration is not performed.

Here, in a relationship between the individual designation signals Sd[1] to Sd[M] included in the print data signal SI input to the coupling state designation circuit 310 and the coupling state designation signals Qc[1] to Qc[M] and Qs[1] to Qs[M] output by the coupling state designation circuit 310 in a period in which the liquid discharge apparatus 1 executes the discharge processing, an example of the decoding contents of the individual designation signals Sd[1] to Sd[M] executed by the coupling state designation circuit 310 will be described.

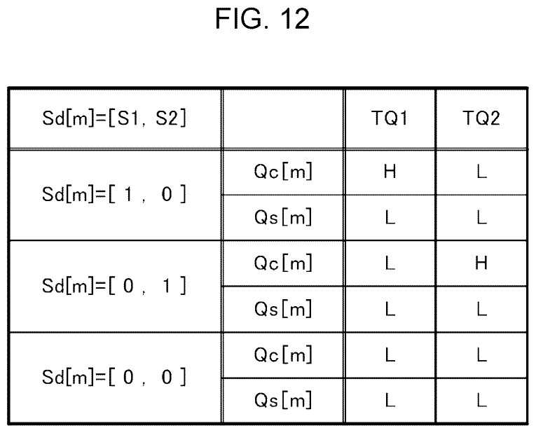

FIG. 12 is a diagram illustrating an example of a relationship between the individual designation signal Sd[m] and the coupling state designation signals Qc[m] and Qs[m] in the period during which the discharge processing is executed.

As illustrated in FIG. 12, when the individual designation signal Sd[m]=[1, 0] is input to the coupling state designation circuit 310, the coupling state designation circuit 310 generates the coupling state designation signal Qc[m] that is at an H level in the control period TQ1 and is at an L level in the control period TQ2, and outputs the coupling state designation signal Qc[m] to the control terminal of the switch Wc[m]. Accordingly, the switch Wc[m] is controlled to be conductive in the control period TQ1 and controlled to be non-conductive in the control period TQ2. Therefore, to the piezoelectric element PZ[m], the supply drive signal VIN[m] including the drive waveform PP1 is supplied in the control period TQ1, and the supply drive signal VIN[m] including the drive waveform PP2 is not supplied in the control period TQ2. Here, in the control period TQ2 in which the supply drive signal VIN[m] including the drive waveform PP2 is not supplied to the piezoelectric element PZ[m], at the upper electrode Zu[m], a voltage value of a signal that is supplied to the upper electrode Zu[m] immediately before, that is, the reference potential V0, is held by a capacitive component of the piezoelectric element PZ[m]. That is, in the control period TQ2 in which the supply drive signal VIN[m] including the drive waveform PP2 is not supplied to the piezoelectric element PZ[m], a constant signal at the reference potential V0 is supplied to the upper electrode Zu[m]. As a result, the ink is discharged from the nozzle N[m] in the control period TQ1, and the ink is not discharged from the nozzle N[m] in the control period TQ2. Then, the ink discharged in the control period TQ1 lands on the medium P, so that dots are formed at the medium P in the unit period TP.

Further, when the individual designation signal Sd[m]=[0, 1] is input to the coupling state designation circuit 310, the coupling state designation circuit 310 generates the coupling state designation signal Qc[m] that is at the L level in the control period TQ1 and is at the H level in the control period TQ2, and outputs the coupling state designation signal Qc[m] to the control terminal of the switch Wc[m]. Accordingly, the switch Wc[m] is controlled to be non-conductive in the control period TQ1 and controlled to be conductive in the control period TQ2. Therefore, to the piezoelectric element PZ[m], the supply drive signal VIN[m] including the drive waveform PP1 is not supplied in the control period TQ1, and the supply drive signal VIN[m] including the drive waveform PP2 is supplied in the control period TQ2. Here, in the control period TQ1 in which the supply drive signal VIN[m] including the drive waveform PP1 is not supplied to the piezoelectric element PZ[m], at the upper electrode Zu[m], a voltage value of a signal that is supplied to the upper electrode Zu[m] immediately before, that is, the reference potential V0, is held by a capacitive component of the piezoelectric element PZ[m]. That is, in the control period TQ1 in which the supply drive signal VIN[m] including the drive waveform PP1 is not supplied to the piezoelectric element PZ[m], a constant signal at the reference potential V0 is supplied to the upper electrode Zu[m]. As a result, the ink is not discharged from the nozzle N[m] in the control periods TQ1 and TQ2, and the micro vibration is executed in the control period TQ2. Therefore, dots are not formed at the medium P in the unit period TP.

Further, when the individual designation signal Sd[m]=[0, 0] is input to the coupling state designation circuit 310, the coupling state designation circuit 310 generates the coupling state designation signal Qc[m] that is at the L level in the control period TQ1 and is at the L level in the control period TQ2, and outputs the coupling state designation signal Qc[m] to the control terminal of the switch Wc[m]. Accordingly, the switch Wc[m] is controlled to be non-conductive in the control period TQ1 and controlled to be non-conductive in the control period TQ2. Therefore, to the piezoelectric element PZ[m], the supply drive signal VIN[m] including the drive waveform PP1 is not supplied in the control period TQ1, and the supply drive signal VIN[m] including the drive waveform PP2 is not supplied in the control period TQ2. That is, when the individual designation signal Sd[m]=[0, 0] is input to the coupling state designation circuit 310, in the unit period TP, the switch Wc[m] continues to be non-conductive. Here, in the control period TQ1 in which the supply drive signal VIN[m] including the drive waveform PP1 is not supplied to the piezoelectric element PZ[m], at the upper electrode Zu[m], a voltage value of a signal supplied to the upper electrode Zu[m] immediately before, that is, the reference potential V0 is held by the capacitive component of the piezoelectric element PZ[m], and in the control period TQ2 in which the supply drive signal VIN[m] including the drive waveform PP2 is not supplied, at the upper electrode Zu[m], a voltage value of a signal supplied to the upper electrode Zu[m] immediately before, that is, the reference potential V0 is held by the capacitive component of the piezoelectric element PZ[m]. That is, a constant signal at the reference potential V0 is supplied to the upper electrode Zu[m] in the unit period TP. As a result, the ink is not discharged from the nozzle N[m] in the control periods TQ1 and TQ2, and the micro vibration is not executed. Therefore, dots are not formed at the medium P in the unit period TP.

As described above, when the liquid discharge apparatus 1 performs the discharge processing, the coupling state designation circuit 310 outputs the coupling state designation signals Qc[1] to Qc[M] having the logic levels based on the individual designation signals Sd[1] to Sd[M] in each of the control periods TQ1 and TQ2 in the unit period TP. As a result, the conductive state of each of the switches Wc[1] to Wc[M] in the control periods TQ1 and TQ2 in the unit period TP are controlled, and it is controlled whether or not the ink is discharged from each of the discharge sections D[1] to D[M] in each of the control periods TQ1 and TQ2 in the unit period TP. Accordingly, the liquid discharge apparatus 1 can form an image corresponding to the image data signal IMG at the medium P in the period during which the discharge processing is executed.

Here, as illustrated in FIG. 11, in the period during which the liquid discharge apparatus 1 is performing the discharge processing, the coupling state designation circuit 310 continues to output the coupling state designation signal Qs[m] at the L level regardless of the input individual designation signal Sd[m]. Therefore, the switch Ws[m] is controlled to be non-conductive in the period during which the discharge processing is being executed. As a result, in the period during which the liquid discharge apparatus 1 executes the discharge processing, the upper electrode Zu[m] and the wiring Ls are not electrically coupled to each other. Therefore, the signal corresponding to the residual vibration generated in the discharge section D[m] is not supplied to the detection circuit 33. Therefore, the detection circuit 33 does not acquire the detection potential signal VX in the period during which the liquid discharge apparatus 1 executes the discharge processing.

Therefore, although not illustrated, in the period during which the liquid discharge apparatus 1 executes the discharge processing, the coupling state designation circuit 310 continues to output the coupling state designation signals Qf, Q1, and Q2 at the L level.

### 5.2 Determination Processing

Next, the determination processing of determining a state of the discharge section D that discharges the ink to the medium P will be described. It is known that residual vibration is generated in a discharge section that discharges a liquid such as ink by driving a drive element such as a piezoelectric element after the drive element is driven. The residual vibration generated in the discharge section is so-called attenuation vibration in which the amplitude decreases with the passage of time, and waveform information such as the amplitude, the amplitude attenuation rate, the period, and the frequency of the attenuation vibration changes depending on the state of the discharge section. For example, when the viscosity of the liquid stored in the discharge section is changed, the amplitude of the residual vibration generated in the discharge section or the amplitude attenuation rate is changed. When air bubbles are mixed in the discharge section, for example, the frequency of the residual vibration generated in the discharge section increases.

In the liquid discharge apparatus 1 of the present embodiment, in the determination processing of determining the state of the discharge section D that discharges the ink to the medium P, the supply switching circuit 31 included in the head unit 3 acquires a signal corresponding to the residual vibration generated in the discharge section D[m] to be inspected and outputs the signal to the detection circuit 33 as the detection potential signal VX, and the detection circuit 33 generates a detection signal SK by shaping the signal waveform of the input detection potential signal VX. The determination unit 7 calculates, based on the input detection signal SK, waveform information such as the amplitude, the period, and the frequency of the detection potential signal VX, that is, waveform information such as the amplitude, the period, and the frequency of the residual vibration generated in the discharge section D[m] to be inspected, and determines a state of the discharge section D[m] to be inspected based on the calculated waveform information. Thereafter, the determination unit 7 generates a state determination signal JH indicating the determination result, and outputs the state determination signal JH to the control unit 2. As a result, the control unit 2 can acquire the state of the discharge section D[m] to be inspected, correct the various signals to be output in accordance with the acquired state of the discharge section D[m] to be inspected, or notify a user of the state of the discharge section D[m] to be inspected.

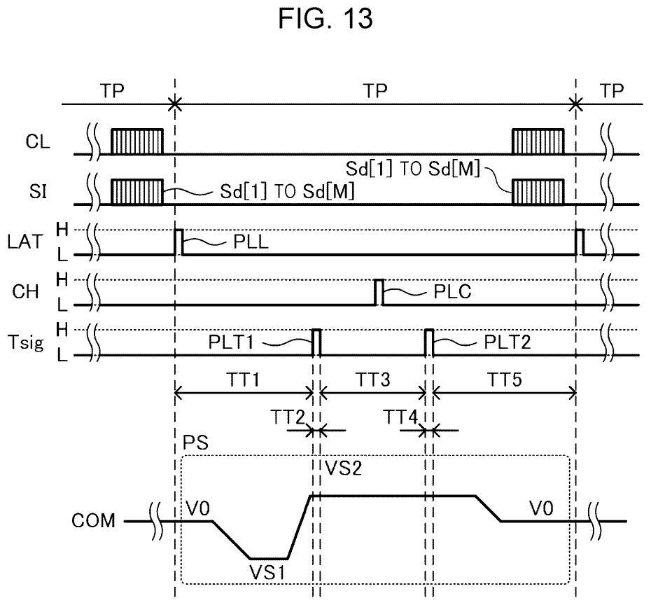

FIG. 13 is a diagram for explaining an example of various signals input to the supply switching circuit 31 of the head unit 3 in a period during which determination processing is executed.

The control unit 2 generates a drive waveform designation signal dCOM that defines a signal waveform of the drive signal COM output by the drive circuit unit 5 in the period during which the determination processing is executed, and outputs the drive waveform designation signal dCOM to the drive circuit unit 5. The drive circuit 50 included in the drive circuit unit 5 generates the drive signal COM including a drive waveform PS for each unit period TP as illustrated in FIG. 13, in accordance with the input drive waveform designation signal dCOM, and supplies the drive signal COM to the head unit 3.

The drive waveform PS is a signal waveform in which, in the control period TT1, a voltage value starts at the reference potential V0, changes to a potential VS1 lower than the reference potential V0, then becomes a potential VS2 higher than the reference potential V0, maintains the potential VS2 in the control periods TT2, TT3, and TT4, and in the control period TT5, ends at the reference potential V0. When the drive waveform PS is supplied to the piezoelectric element PZ[m], the piezoelectric element PZ[m] is driven so that ink is not discharged from the nozzle N[m], and after the piezoelectric element PZ[m] is driven, the predetermined residual vibration is generated in the discharge section D[m] at the timing when the voltage value of the drive signal COM becomes the potential VS2. That is, the drive waveform PS is a signal waveform for driving the piezoelectric element PZ[m] so that the ink is not discharged from the nozzle N[m] and for generating the predetermined residual vibration in the discharge section D[m]. Therefore, when the drive waveform PS is supplied to the piezoelectric element PZ[m], the discharge section D[m] does not discharge the ink and operates so that the residual vibration is generated.

The liquid discharge apparatus 1 controls the conductive state of each of the switches Wc[1] to Wc[M], Ws[1] to Ws[M], Wf, W1, and W2 in each of the control periods TT1 to TT5 for each unit period TP in the period during which the determination processing is executed, and supplies the supply drive signal VIN[m] including the drive waveform PS to the discharge section D[m] to be inspected, acquires a signal according to the residual vibration generated in the discharge section D[m] to be inspected due to the supply of the supply drive signal VIN[m] including the drive waveform PS, and outputs the signal to the detection circuit 33 as the detection potential signal VX.

The detection circuit 33 generates a detection signal SK by shaping the signal waveform of the input detection potential signal VX, and the determination unit 7 determines a state of the discharge section D[m] to be inspected based on the detection signal SK.

Here, in a relationship between the individual designation signals Sd[1] to Sd[M] included in the print data signal SI input to the coupling state designation circuit 310 in the period during which the liquid discharge apparatus 1 executes the determination processing and the coupling state designation signals Qc[1] to Qc[M], Qs[1] to Qs[M], Qf, Q1, and Q2 output by the coupling state designation circuit 310, an example of the decoding contents of the individual designation signals Sd[1] to Sd[M] executed by the coupling state designation circuit 310 in the period during which the determination processing is executed will be described.

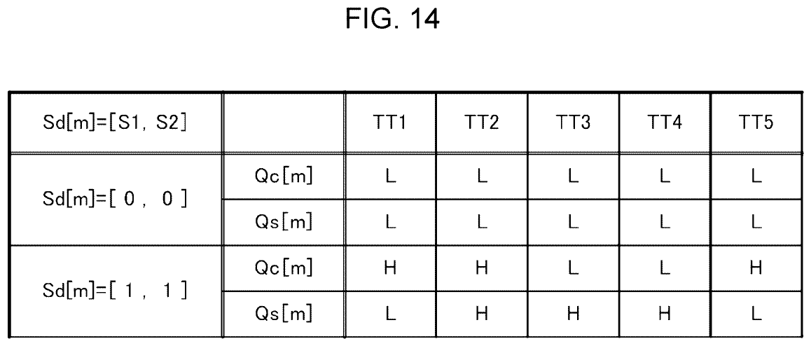

FIG. 14 is a diagram illustrating an example of a relationship between the individual designation signal Sd[m] and coupling state designation signals Qc[m] and Qs[m] in the period during which the determination processing is executed. Here, in the liquid discharge apparatus 1 of the present embodiment, in a period during which the determination processing is executed, when the discharge section D[m] is not an inspection target, it is described as that the control unit 2 outputs an individual designation signal Sd[m]=[0, 0] to the coupling state designation circuit 310, and when the discharge section D[m] is the inspection target, it is described as that the control unit 2 outputs an individual designation signal Sd[m]=[1, 1] to the coupling state designation circuit 310, as an explanation.

As described above, when the individual designation signal Sd[m]=[0, 0] is input to the coupling state designation circuit 310, the coupling state designation circuit 310 keeps the switch Wc[m] non-conductive in the unit period TP. Therefore, as illustrated in FIG. 14, when the individual designation signal Sd[m]=[0, 0] is input to the coupling state designation circuit 310, the coupling state designation circuit 310 generates the coupling state designation signal Qc[m] that is at the L level in the control periods TT1 to TT5, outputs the coupling state designation signal Qc[m] to the control terminal of the switch Wc[m], generates the coupling state designation signal Qs[m] that is at the L level in the control periods TT1 to TT5, and outputs the coupling state designation signal Qs[m] to the control terminal of the switch Ws[m]. Accordingly, in the control periods TT1 to TT5, the switch Wc[m] is controlled to be non-conductive, and the switch Ws[m] is controlled to be non-conductive. At this time, the supply drive signal VIN[m] corresponding to the drive signal COM is not supplied to the piezoelectric element PZ[m] of a discharge section D[m] that is not an inspection target. Therefore, the residual vibration is not generated in the discharge section D[m] that is not the inspection target, and in this case, even when the potential of the upper electrode Zu[m] of the piezoelectric element PZ[m] included in the discharge section D[m] that is not the inspection target changes, the signal accompanying the change in the potential is not supplied to the wiring Ls. That is, the determination of the state of the discharge section D[m] that is not the inspection target is not executed.

Further, when the individual designation signal Sd[m]=[1, 1] is input to the coupling state designation circuit 310, the coupling state designation circuit 310 generates the coupling state designation signal Qc[m] that is at the H level in the control periods TT1, TT2, and TT5 and is at the L level in the control periods TT3 and TT4, outputs the coupling state designation signal Qc[m] to the control terminal of the switch Wc[m], generates the coupling state designation signal Qs[m] that is at the H level in the control periods TT2 to TT4 and is at the L level in the control periods TT1 and TT5, and outputs the coupling state designation signal Qs[m] to the control terminal of the switch Ws[m]. As a result, the switch Wc[m] is controlled to be conductive in the control periods TT1, TT2, and TT5 and is controlled to be non-conductive in the control periods TT3 and TT4, and the switch Ws[m] is controlled to be conductive in the control periods TT2 to TT4 and is controlled to be non-conductive in the control periods TT1 and TT5.

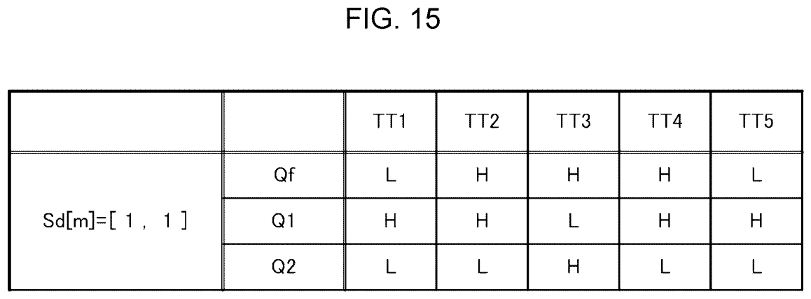

FIG. 15 is a diagram illustrating an example of a relationship between the individual designation signal Sd[m] and coupling state designation signals Of, 01, and 02 in the period during which the determination processing is executed. Here, in the period during which the determination processing is executed, when at least one of the individual designation signals Sd[1] to Sd[M] included in the input print data signal SI is [1, 1], the coupling state designation circuit 310 generates the coupling state designation signal Of that is at the H level in the control periods TT2 to TT4 and is at the L level in the control periods TT1 and TT5, outputs the coupling state designation signal Qf to the control terminal of the switch Wf, generates the coupling state designation signal Q1 that is at the H level in the control periods TT1, TT2, TT4, and TT5 and is at the L level in the control period TT3, outputs the coupling state designation signal Q1 to the control terminal of the switch W1, generates the coupling state designation signal Q2 that is at the H level in the control period TT3 and is at the L level in the control periods TT1, TT2, TT4, and TT5, and outputs the coupling state designation signal Q2 to the control terminal of the switch W2. Accordingly, the switch Wf is controlled to be conductive in the control periods TT2 to TT4 and controlled to be non-conductive in the control periods TT1 and TT5, the switch W1 is controlled to be conductive in the control periods TT1, TT2, TT4, and TT5 and controlled to be non-conductive in the control period TT3, and the switch W2 is controlled to be conductive in the control period TT3 and controlled to be non-conductive in the control periods TT1, TT2, TT4, and TT5.

Here, in an operation of the liquid discharge apparatus 1 when the individual designation signal Sd[m]=[1, 1] corresponding to the discharge section D[m] to be inspected is input to the coupling state designation circuit 310, an example of an acquisition operation in which the detection circuit 33 acquires a detection potential signal VX based on a signal corresponding to the residual vibration generated in the discharge section D[m] to be inspected will be described.

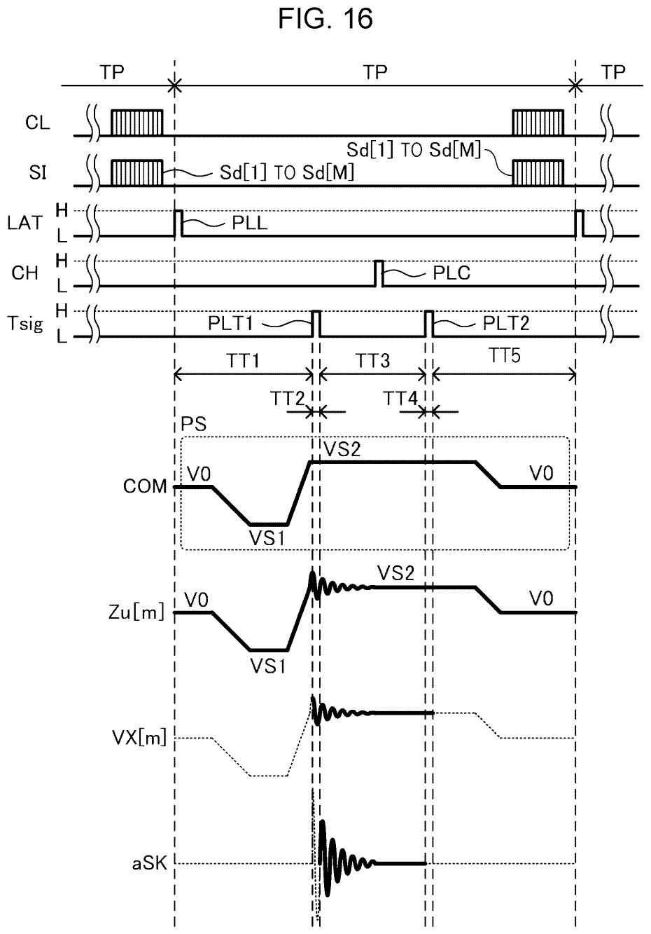

FIG. 16 is a diagram for explaining an example of an operation of acquiring a detection potential signal VX based on a signal corresponding to the residual vibration generated in the discharge section D[m] to be inspected. As illustrated in FIG. 16, for each unit period TP in the period during which the determination processing is executed, the coupling state designation circuit 310 is supplied with the drive signal COM including the drive waveform PS in which the voltage value starts at the reference potential V0 in the control period TT1, changes to the potential VS1 lower than the reference potential V0, becomes the potential VS2 higher than the reference potential V0, maintains the potential VS2 in the control periods TT2 to TT4, and ends at the reference potential V0 in the control period TT5.

Then, in the period during which the determination processing is executed, the control unit 2 outputs the individual designation signal Sd[m]=[1, 1] corresponding to the discharge section D[m] to be inspected to the coupling state designation circuit 310. At this time, the discharge sections D[1] to D[m−1] and D[m+1] to D[M] are not the target of the inspection. That is, the control unit 2 outputs the individual designation signals Sd[1] to Sd[m−1], and Sd[m+1] to Sd[M]=[0, 0] to the coupling state designation circuit 310.

When the print data signal SI including the individual designation signal Sd[m]=[1, 1] and the individual designation signals Sd[1] to Sd[m−1], Sd[m+1] to Sd[M]=[0, 0] is input to the coupling state designation circuit 310, the switch Wc[m] is controlled to be conductive in the control periods TT1 and TT2, and the switches Wc[1] to Wc[m−1] and Wc[m+1] to Wc[M] are controlled to be non-conductive. Therefore, the upper electrode Zu[m] is supplied with the supply drive signal VIN[m] in which a voltage value starts at the reference potential V0 in the control periods TT1 and TT2, changes to the potential VS1 lower than the reference potential V0, then becomes the potential VS2 higher than the reference potential V0, and maintains the potential VS2, and at the upper electrodes Zu[1] to Zu[m−1] and Zu[m+1] to Zu[M], the reference potential V0 is held. At this time, in the discharge section D[m] to be inspected, the residual vibration is generated at the timing when the voltage value of the supply drive signal VIN[m] to be supplied becomes constant at the potential VS2. The piezoelectric body Zm[m] is deformed according to the residual vibration generated in the discharge section D[m] to be inspected, and the electromotive force corresponding to the deformation of the piezoelectric body Zm[m] is generated in the upper electrode Zu[m]. That is, a signal corresponding to the residual vibration generated in the discharge section D[m] to be inspected is generated in the upper electrode Zu[m] of the piezoelectric element PZ[m] included in the discharge section D[m] to be inspected.

In the control period TT2, the switch Ws[m] is controlled to be conductive, the switches Ws[1] to Ws[m−1] and Ws[m+1] to Ws[M] are controlled to be non-conductive, and the switch Wf is controlled to be conductive. Therefore, the signal corresponding to the residual vibration generated in the discharge section D[m] to be inspected propagates through the wiring Ls as the detection potential signal VX. At this time, the switch W1 is controlled to be conductive, and the switch W2 is controlled to be non-conductive. Therefore, in the control period TT2, the waveform shaping circuit 330 included in the detection circuit 33 does not acquire the detection potential signal VX propagating through the wiring Ls, and thus does not output the detection signal aSK corresponding to the detection potential signal VX.

In the control period TT3, the switch W1 is controlled to be non-conductive and the switch W2 is controlled to be conductive. Thus, the waveform shaping circuit 330 included in the detection circuit 33 acquires the detection potential signal VX that is a signal corresponding to the residual vibration generated in the discharge section D[m] to be inspected and that propagates through the wiring Ls, shapes the signal waveform of the acquired detection potential signal VX, and outputs the shaped signal waveform as the detection signal aSK. The detection signal aSK output by the waveform shaping circuit 330 is converted into a digital signal in the AD conversion circuit 331, and then is input, as the detection signal SK, to the determination unit 7.

The determination unit 7 calculates, based on the input detection signal SK, waveform information such as the amplitude, the period, and the frequency of the detection potential signal VX, that is, waveform information such as the amplitude, the period, and the frequency of the residual vibration generated in the discharge section D[m] to be inspected. The determination unit 7 determines a state of the discharge section D[m] to be inspected based on the calculated waveform information, and outputs a state determination signal JH indicating the determination result to the control unit 2.

Specifically, when the amplitude or the amplitude attenuation rate of the residual vibration included in the calculated waveform information is different from the amplitude or the amplitude attenuation rate of the residual vibration generated in the normal discharge section D, the determination unit 7 determines that the abnormality occurs in the viscosity of the liquid stored in the discharge section D to be inspected, and when the frequency of the residual vibration included in the calculated waveform information is different from the frequency of the residual vibration generated in the normal discharge section D, the determination unit 7 determines that the air bubbles are mixed in the discharge section D to be inspected. In addition, when the short-circuit abnormality occurs in the piezoelectric element PZ included in the discharge section D to be inspected, the piezoelectric element PZ does not output a signal corresponding to the residual vibration even when the residual vibration is generated in the discharge section D. When the residual vibration of the discharge section D to be inspected is not detected from the calculated waveform information, the determination unit 7 determines that the short-circuit abnormality occurs in the piezoelectric element PZ included in the discharge section D to be inspected. That is, the determination unit 7 determines a state of the discharge section D[m] to be inspected based on the input detection signal SK, and outputs the state determination signal JH indicating the determination result to the control unit 2.

Thereafter, in the control period TT4, the switch W1 is controlled to be conductive and the switch W2 is controlled to be non-conductive, so that the waveform shaping circuit 330 stops acquiring the detection potential signal VX propagating through the wiring Ls and outputting the detection signal aSK. In the control period TT5, the switch Wc[m] is controlled to be conductive and the switch Ws[m] is controlled to be non-conductive. Therefore, the supply of the signal generated in the upper electrode Zu[m] to the wiring Ls is stopped, and the supply drive signal VIN[m] of the reference potential V0 is supplied to the upper electrode Zu[m] of the piezoelectric element PZ[m] included in the discharge section D[m] to be inspected. Accordingly, the potential of the upper electrode Zu[m] of the piezoelectric element PZ[m] included in the discharge section D[m] to be inspected is controlled to the reference potential V0.

### 5.3 Maintenance Processing

Next, an example of the maintenance processing of attempting to recover the discharge state of the discharge section D in which the discharge abnormality occurs in the determination processing will be described. The maintenance processing of the present embodiment includes a pump suction processing, a flushing processing, and a wiping processing. The maintenance processing is not limited thereto, and includes various types of processing for recovering the discharge state of the discharge section D.

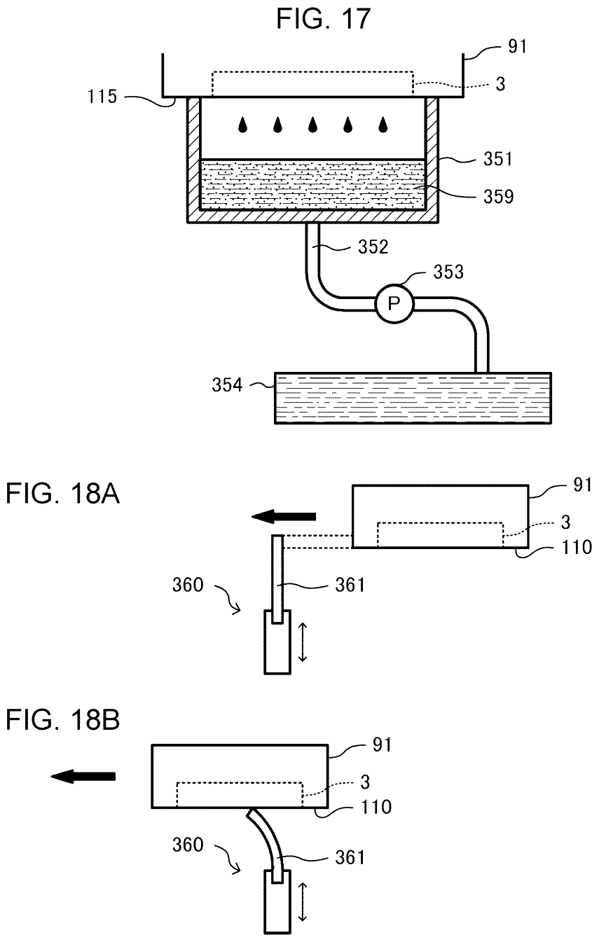

FIG. 17 is a diagram illustrating an example of pump suction processing. As illustrated in FIG. 17, the pump suction processing is executed by using a cap 351, a tube 352, a pump 353, and a waste liquid tank 354.

The cap 351 is located to cover the plurality of head units 3 mounted on the carriage 91 from the discharge surface 115 side. One end of the tube 352 is attached to the cap 351. The other end of the tube 352 is coupled to the waste liquid tank 354 via the pump 353.

The air inside the cap 351 is drawn by the operation of the pump 353. Accordingly, the ink stored in the plurality of discharge sections D included in the head unit 3 is introduced toward the waste liquid tank 354. At this time, the ink adhering to the vicinity of the nozzle N of the discharge section D, the air bubbles mixed in the discharge section D, and the like are removed.

In addition, as illustrated in FIG. 17, the cap 351 may have an ink absorber 359 inside. The ink absorber 359 absorbs ink sucked from the nozzle N and temporarily stores the ink in the pump suction processing. As a result, in the period during which the pump suction processing is executed, the possibility that the sucked ink bounces back and adheres to the discharge surface 115 can be reduced.

FIGS. 18A and 18B are diagrams illustrating examples of the wiping processing. As illustrated in FIGS. 18A and 18B, the wiping processing is performed by a wiper 360 including a wiping member 361. As illustrated in FIG. 18A, the wiper 360 includes a range in which the wiping member 361 can abut on the discharge surface 115, and is provided to be movable in an up-and-down direction in FIGS. 18A and 18B. When the wiping processing is executed, the wiper 360 moves such that at least a part of the wiping member 361 is positioned on the side above the discharge surface 115 in FIGS. 18A and 18B. Thereafter, the carriage 91 on which the head unit 3 is mounted is moved in a direction along the arrow illustrated in FIGS. 18A and 18B by the operation of the carriage movement unit 9. As a result, the wiping member 361 abuts on the discharge surface 115 as illustrated in FIG. 18B.

Here, the wiping member 361 is made of a plastic rubber or the like. Therefore, when the wiping member 361 abuts on the discharge surface 115, a distal end portion of the wiping member 361 is bent. Accordingly, the wiping member 361 can wipe a surface of the discharge surface 115, and the paper pieces or the like adhering to the discharge surface 115 are removed.

In the flushing processing, for example, the ink is discharged simultaneously from the plurality of nozzles N included in the plurality of discharge sections D of the target head unit 3 in a state in which the cap 351 illustrated in FIG. 17 is mounted. With the flushing processing, the ink stored in the plurality of discharge sections D included in the head unit 3 is refreshed. As a result, the viscosity of the ink stored in the plurality of discharge sections D included in the head unit 3 is maintained in an appropriate range, and the viscosity of the ink is recovered to the appropriate range. In the flushing processing, it is sufficient that the ink can be discharged simultaneously from the plurality of nozzles N included in the plurality of discharge sections D of the head unit 3. Therefore, in the flushing processing, by inputting a predetermined print data signal SI to the head unit 3 in a state in which the cap 351 is mounted on the head unit 3, the drive signal COM including the predetermined signal waveform may be supplied to the plurality of discharge sections D, and the ink may be discharged simultaneously from the plurality of nozzles N included in the plurality of discharge sections D.

Here, the control unit 2 may select any of the pump suction processing, the flushing processing, and the wiping processing described above, as the maintenance processing, based on the state determination signal JH output by the determination unit 7 described above, and cause the maintenance unit 10 to execute the selected processing. For example, when the control unit 2 determines that the factor of the discharge abnormality occurring in the discharge section D is the mixing of air bubbles into the discharge section D based on the state determination signal JH, the control unit 2 causes the maintenance unit 10 to execute the pump suction processing, and when the control unit 2 determines that the factor of the discharge abnormality occurring in the discharge section D is the thickening of the ink based on the state determination signal JH, the control unit 2 causes the maintenance unit 10 to execute the flushing processing or the pump suction processing. When the control unit 2 determines that the factor of the discharge abnormality occurring in the discharge section D is the adhesion of paper pieces to the discharge surface 115 based on the state determination signal JH, the control unit 2 causes the maintenance unit 10 to execute the wiping processing. As a result, the maintenance unit 10 attempts to recover the state of the discharge section D in which the discharge abnormality occurs.

Further, when the discharge abnormality occurs in the plurality of discharge sections D of the head unit 3, the maintenance unit 10 may execute all of the pump suction processing, the flushing processing, and the wiping processing regardless of the factor of the discharge abnormality.

That is, the liquid discharge apparatus 1 of the present embodiment includes the maintenance unit 10 that executes the maintenance processing of the discharge section D in an attempt to recover the state of the discharge section D, and the maintenance unit 10 executes, as the maintenance processing, the wiping processing of wiping the discharge surface 115 from which the ink is discharged from the head unit 3 and the recording head 32, and the flushing processing of discharging the liquid from the plurality of discharge sections D in order to recover the viscosity of the stored ink.

### 6. Operation of Liquid Discharge Apparatus

The operation of the liquid discharge apparatus 1 that executes various types of processing including the discharge processing, the determination processing, and the maintenance processing as described above will be described.

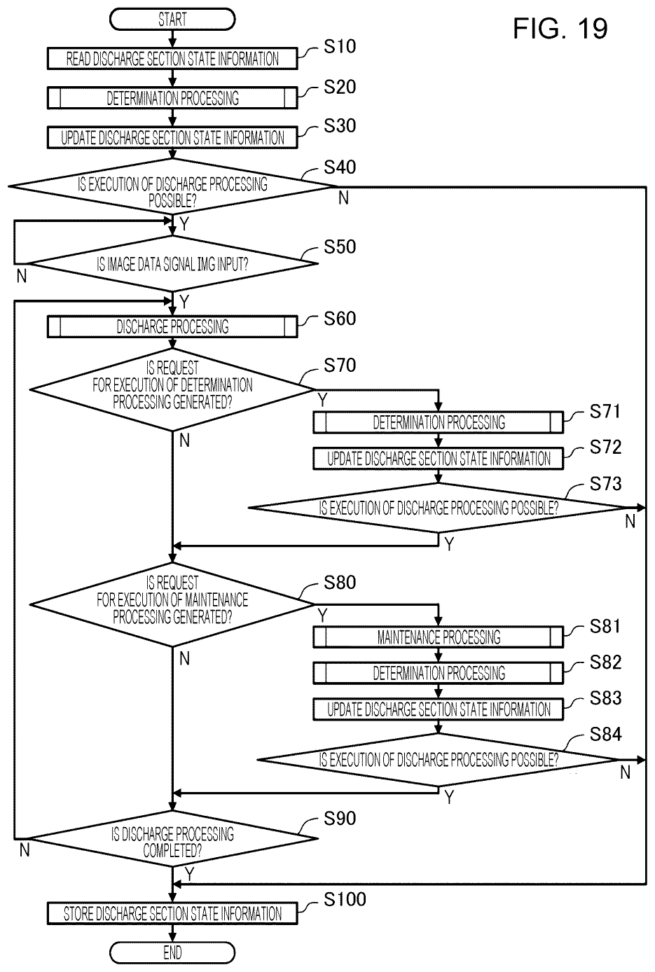

FIG. 19 is a diagram for explaining an operation of the liquid discharge apparatus 1. As illustrated in FIG. 19, when the liquid discharge apparatus 1 starts the operation, the control unit 2 reads discharge section state information from a memory circuit (not illustrated) and holds the discharge section state information (Step S10). Here, the discharge section state information read and held by the control unit 2 is information related to the discharge states of the discharge sections D[1] to D[M] stored in the memory circuit of the control unit 2 according to the state determination signal JH input to the control unit 2 in the determination processing, and includes, for example, information on whether or not the discharge abnormality occurs in each of the discharge sections D[1] to D[M], information on the type of the discharge abnormality of the discharge section D in which the discharge abnormality occurs, information on the number of discharge sections D in which the discharge abnormality occurs among the discharge sections D[1] to D[M], and the like.

Thereafter, the liquid discharge apparatus 1 executes the determination processing described with reference to FIGS. 13 to 16 (Step S20). Specifically, when the determination processing is started, the control unit 2 generates a clock signal CL, a print data signal SI, a latch signal LAT, a change signal CH, a period designation signal Tsig, and a drive waveform designation signal dCOM for the discharge section D[1] as the discharge section D to be inspected, and outputs the generated signals to the corresponding configuration. As a result, the state determination signal JH corresponding to the discharge section D[1] is input to the control unit 2. As a result, the control unit 2 acquires the information on the determination result as to whether or not the discharge abnormality occurs in the discharge section D[1] and the information on the type of the discharge abnormality when the discharge abnormality occurs in the discharge section D[1].

Similarly, the control unit 2 generates the clock signal CL, the print data signal SI, the latch signal LAT, the change signal CH, the period designation signal Tsig, and the drive waveform designation signal dCOM for designating the discharge sections D[2] to D[M] in order as the discharge sections D to be inspected, and outputs the generated signals to the corresponding configuration. Accordingly, the state determination signals JH corresponding to each of the discharge sections D[2] to D[M] are sequentially input to the control unit 2. That is, the control unit 2 sequentially acquires the information on the determination result as to whether or not the discharge abnormality occurs in each of the discharge sections D[2] to D[M] and the information on the type of the discharge abnormality when the discharge abnormality occurs.

Here, in the following description, it is described that the control unit 2 acquires all the determination results as to whether or not the discharge abnormality occurs in each of the discharge sections D[1] to D[M] in one determination processing, but the control unit 2 may be configured to execute the determination as to whether or not the discharge abnormality occurs in each of the discharge sections D[1] to D[M] by dividing the determination into a plurality of determination processing. For example, the control unit 2 may acquire the determination result as to whether or not the discharge abnormality occurs in each of the discharge sections D[1] to D[m] among the discharge sections D[1] to D[M] in the first determination processing, and may acquire the determination result as to whether or not the discharge abnormality occurs in each of the discharge sections D[m+1] to D[M] among the discharge sections D[1] to D[M] in the second determination processing.

After the determination processing in Step S20 is completed, the control unit 2 updates the held discharge section state information in accordance with the acquired determination result as to whether or not the discharge abnormality occurs in each of the discharge sections D[1] to D[M] (Step S30). That is, the control unit 2 updates the held information on whether or not the discharge abnormality occurs in each of the discharge sections D[1] to D[M], the information on the type of the discharge abnormality when the discharge abnormality occurs, and the information on the number of the discharge sections D in which the discharge abnormality occurs among the discharge sections D[1] to D[M], based on the determination result of the determination processing in Step S20.

Then, the control unit 2 determines whether or not the execution of the discharge processing is possible based on the held and updated discharge section state information (Step S40). Specifically, the control unit 2 determines whether or not the discharge section D in which the discharge abnormality occurs can be complemented by the complementary processing, based on information on whether or not the discharge abnormality occurs in each of the discharge sections D[1] to D[M] included in the held discharge section state information. Then, the control unit 2 may determine that the execution of the discharge processing is possible when the complementary processing is possible, and may determine that the execution of the discharge processing is not possible when the complementary processing is not possible. In addition, the control unit 2 determines whether or not the number of the discharge sections D in which the discharge abnormality occurs exceeds a predetermined number, among the discharge sections D[1] to D[M] included in the held discharge section state information. Then, when the number of discharge sections D in which the discharge abnormality occurs is equal to or less than the predetermined number, the control unit 2 may determine that the execution of the discharge processing is possible, and when the number of discharge sections D in which the discharge abnormality occurs exceeds the predetermined number, the control unit 2 may determine that the execution of the discharge processing is not possible. When the control unit 2 determines that the execution of the discharge processing is not possible (N in Step S40), the control unit 2 ends the processing, and the liquid discharge apparatus 1 stops the operation. At this time, the control unit 2 may notify the user that the execution of the discharge processing is not possible via a notification function (not illustrated).

When the control unit 2 determines that the execution of the discharge processing is possible (Y in step S40), the control unit 2 determines whether or not the image data signal IMG is input (Step S50), and when the image data signal IMG is not input (N in Step S50), the control unit 2 stands by for a period until the image data signal IMG is input.

Thereafter, when the image data signal IMG is input to the control unit 2 (Y in Step S50), the liquid discharge apparatus 1 executes the discharge processing described with reference to FIGS. 11 and 12 (Step S60). Specifically, when the discharge processing is started, the control unit 2 generates individual designation signals Sd[1] to Sd[M] according to the input image data signal IMG. Then, the control unit 2 generates print data signal SI by performing the complementary processing to complement the discharge of the ink from the discharge section D in which the discharge abnormality including the short-circuit abnormality occurs, by setting the individual designation signal Sd=[0, 0] corresponding to the discharge section D in which the short-circuit abnormality of the piezoelectric element PZ occurs, among the generated individual designation signals Sd[1] to Sd[M], and setting the individual designation signal Sd=[0, 1] corresponding to the discharge section D in which the discharge abnormality other than the short-circuit abnormality of the piezoelectric element PZ occurs, based on the held discharge section state information. Thereafter, the control unit 2 outputs the generated print data signal SI, the clock signal CL, the latch signal LAT, the change signal CH, the period designation signal Tsig, and the drive waveform designation signal dCOM to corresponding configurations. As a result, the head unit 3 discharges the ink in response to the print data signal SI, the clock signal CL, the latch signal LAT, the change signal CH, the period designation signal Tsig, and the drive waveform designation signal dCOM. As a result, the dots are formed at predetermined positions on the medium P.

That is, when the determination unit 7 determines that the short-circuit abnormality occurs in the discharge section D[1], the switch Wc[1] does not supply the drive signal COM to the piezoelectric element PZ[1] in the unit period TP of the period during which the discharge processing of discharging the ink from the head unit 3 is executed. When the determination unit 7 determines that the short-circuit abnormality occurs in the discharge section D[m], the switch Wc[m] does not supply the drive signal COM to the piezoelectric element PZ[m] in the unit period TP of the period during which the discharge processing of discharging the ink from the head unit 3 is executed. When the determination unit 7 determines that the discharge abnormality including the short-circuit abnormality occurs in the discharge section D[1], the switch Wc[1] may not supply the drive signal COM to the piezoelectric element PZ[1] in the unit period TP of the period during which the discharge processing of discharging the ink from the head unit 3 is executed. When the determination unit 7 determines that the discharge abnormality including the short-circuit abnormality occurs in the discharge section D[m], the switch Wc[m] may not supply the drive signal COM to the piezoelectric element PZ[m] in the unit period TP of the period during which the discharge processing of discharging the ink from the head unit 3 is executed.

When the determination unit 7 determines that the short-circuit abnormality or the discharge abnormality including the short-circuit abnormality occurs in the discharge section D[1], the discharge section D[2] located adjacent to the discharge section D[1] and determined by the determination unit 7 not to have the discharge abnormality including the short-circuit abnormality discharges ink so as to complement the discharge section D[1] in the unit period TP of the period during which the discharge processing of discharging the ink from the head unit 3 is executed. When the determination unit 7 determines that the short-circuit abnormality or the discharge abnormality including the short-circuit abnormality occurs in the discharge section D[m], at least one of the discharge section D[m−1] and the discharge section D[m+1] located adjacent to the discharge section D[m] and determined by the determination unit 7 not to have the discharge abnormality including the short-circuit abnormality discharges ink so as to complement the discharge section D[m] in the unit period TP of the period during which the discharge processing of discharging the ink from the head unit 3 is executed.

Further, the control unit 2 determines whether or not a request for execution of the determination processing is generated (Step S70). Such a request for execution of the determination processing is generated, for example, at a timing when an operation direction of the carriage 91 on which the head unit 3 is mounted is switched or between sheets of the medium P to be transported.

When the control unit 2 determines that the request for execution of the determination processing is generated (Y in Step S70), the liquid discharge apparatus 1 executes the same determination processing as in Step S20 (Step S71), and the control unit 2 updates the held discharge section state information in accordance with the determination result in the determination processing in Step S71, in the same manner as in Step S30 (Step S72). Then, the control unit 2 determines whether or not the execution of the discharge processing is possible, based on the updated discharge section state information held and updated in Step S72, in the same manner as in Step S40 (Step S73). When the control unit 2 determines that the execution of the discharge processing is not possible (N in Step S73), the control unit 2 ends the processing, and the liquid discharge apparatus 1 stops the operation.

Then, when the control unit 2 determines that the execution of the discharge processing is possible (Y in Step S73) or determines that the request for execution of the determination processing is not generated (N in Step S70), the control unit 2 determines whether or not the request for execution of the maintenance processing is generated (Step S80). For example, such a request for execution of maintenance processing may be generated, after it is determined that a new discharge abnormality occurs in the discharge sections D[1] to D[M] in the determination processing, at a timing when the operation direction of the carriage 91 on which the head unit 3 is mounted is switched, or between sheets of the medium P to be transported, or may be generated after a cumulative operating time or a continuous operating time of the liquid discharge apparatus 1 or the number of surfaces of the medium P on which the ink is discharged reaches a predetermined threshold value, at a timing when the operation direction of the carriage 91 on which the head unit 3 is mounted is switched, or between sheets of the medium P to be transported, or at a timing when formation of an image corresponding to the image data signal IMG is completed.

When the control unit 2 determines that the request for execution of the maintenance processing is generated (Y in Step S80), the control unit 2 causes the maintenance unit 10 to execute the maintenance processing such as the pump suction processing, the flushing processing, and the wiping processing described above (Step S81). After the maintenance processing in the maintenance unit 10 is completed, the liquid discharge apparatus 1 executes the determination processing as in Step S20 (Step S82), and the control unit 2 updates the held discharge section state information in accordance with the determination result in the determination processing in Step S82 in the same manner as in Step S30 (Step S83). Then, the control unit 2 determines whether or not the execution of the discharge processing is possible based on the updated discharge section state information in Step S83, in the same manner as in Step S40 (Step S84). When the control unit 2 determines that the execution of the discharge processing is not possible (N in Step S84), the control unit 2 ends the processing, and the liquid discharge apparatus 1 stops the operation.

Then, when the control unit 2 determines that the request for execution of the maintenance processing is not generated (N in Step S80) or determines that the execution of the discharge processing is possible (Y in Step S84), the control unit 2 determines whether or not the discharge processing corresponding to the image data signal IMG is completed, which is the formation of the image corresponding to the image data signal IMG on the medium P (Step S90). When the control unit 2 determines that the discharge processing corresponding to the image data signal IMG is not completed (N in Step S90), the processing of Steps S60 to S80 described above is repeatedly executed.

On the other hand, when the control unit 2 determines that the discharge processing corresponding to the image data signal IMG is completed (Y in Step S90), or after the control unit 2 determines that the execution of the discharge processing is not possible (N in Step S40, N in Step S73, N in Step S84) and before the liquid discharge apparatus 1 stops the operation, the control unit 2 stores the held discharge section state information in a memory circuit (not illustrated) of the control unit 2 (Step S100). The liquid discharge apparatus 1 stops the operation.

The head unit 3 and the recording head 32 included in the head unit 3 are examples of a print head, the discharge sections D[1] to D[M] are examples of a plurality of discharge sections, any one of the discharge sections D[1] to D[M], for example, the discharge section D[1], is an example of a first discharge section, and in this case, the piezoelectric element PZ[1] included in the discharge section D[1] is an example of a first piezoelectric element, the switch Wc[1] corresponding to the piezoelectric element PZ[1] is an example of a first switch circuit, any one of the discharge sections D[1] to D[M], for example, the discharge section D[m], is an example of a second discharge section, and in this case, the piezoelectric element PZ[m] included in the discharge section D[m] is an example of a second piezoelectric element, the switch Wc[m] corresponding to the piezoelectric element PZ[m] is an example of a second switch circuit, and any one of the discharge sections D[1] to D[M], for example, the discharge section D[2] located adjacent to the discharge section D[1] is an example of a third discharge section. In addition, the determination unit 7 is an example of a state determination circuit, the maintenance unit 10 is an example of a maintenance section, the transistor 403 is an example of a switch circuit, the resistor 410 is an example of a resistive element, the wiring Lb is an example of a first wiring, and the wiring Lg is an example of a second wiring. The unit period TP in which the discharge processing is performed, that is, a period during which the discharge processing in which ink is discharged from the head unit 3 is executed, is an example of a discharge period.

### 7. Action and Effect

As described above, the liquid discharge apparatus 1 of the present embodiment includes a head unit 3 having discharge sections D[1] to D[M] including a discharge section D[1] configured to discharge ink by driving a piezoelectric element PZ[1] and a discharge section D[m] configured to discharge the ink by driving a piezoelectric element PZ[m], a drive circuit 50 configured to output a drive signal COM supplied to an upper electrode Zu[1], which is one end of the piezoelectric element PZ[1], and an upper electrode Zu[m], which is one end of the piezoelectric element PZ[m], a reference voltage circuit 530 configured to output a reference voltage signal VBS supplied to a lower electrode Zd [1], which is the other end of the piezoelectric element PZ[1], and a lower electrode Zd [m], which is the other end of the piezoelectric element PZ[m], a switch Wc[1] configured to switch whether or not to supply the drive signal COM to the upper electrode Zu[1], which is the one end of the piezoelectric element PZ[1], a switch Wc[m] configured to switch whether or not to supply the drive signal COM to the upper electrode Zu[m], which is the one end of the piezoelectric element PZ[m], a determination unit 7 configured to determine a state of each of the discharge sections D[1] to D[M], and a sink circuit 40 configured to switch an impedance value between a wiring Lb through which the reference voltage signal VBS propagates and a wiring Lg through which a signal at a ground potential lower than the reference voltage signal VBS propagates. In the liquid discharge apparatus 1 of the present embodiment, when the determination unit 7 determines that a short-circuit abnormality occurs in the discharge section D[1], the switch Wc[1] does not supply the drive signal COM to the piezoelectric element PZ[1] in a unit period TP during which the discharge processing of discharging the ink from the head unit 3 is executed, and when the determination unit 7 determines that the short-circuit abnormality occurs in the discharge section D[m], the switch Wc[m] does not supply the drive signal COM to the piezoelectric element PZ[m] in the unit period TP during which the discharge processing of discharging the ink from the head unit 3 is executed.

In the liquid discharge apparatus 1 of the present embodiment configured as described above, when the short-circuit abnormality occurs in the piezoelectric element PZ[1] included in the discharge section D[1], the switch Wc[1] does not supply the drive signal COM to the piezoelectric element PZ[1]. Therefore, the possibility that a surplus current flows into the wiring Lb through which the reference voltage signal VBS propagates via the piezoelectric element PZ[1] is reduced. Therefore, a possibility that a voltage value of the wiring Lb through which the reference voltage signal VBS propagates increases due to the occurrence of the short-circuit abnormality in the piezoelectric element PZ[1] included in the discharge section D[1] is reduced. Similarly, when the short-circuit abnormality occurs in the piezoelectric element PZ[m] included in the discharge section D[m], the switch Wc[m] does not supply the drive signal COM to the piezoelectric element PZ[m]. Therefore, the possibility that a surplus current flows into the wiring Lb through which the reference voltage signal VBS propagates via the piezoelectric element PZ[m] is reduced. Therefore, a possibility that a voltage value of the wiring Lb through which the reference voltage signal VBS propagates increases due to the occurrence of the short-circuit abnormality in the piezoelectric element PZ[m] included in the discharge section D[m] is reduced. That is, in the liquid discharge apparatus 1 of the present embodiment, when the short-circuit abnormality occurs in the discharge section D including the piezoelectric element PZ, and an image can be formed at the medium P in the discharge section D in which no abnormality occurs, the image can be continuously formed at the medium P without the image quality of the liquid discharge apparatus 1 being deteriorated.

In addition, in the liquid discharge apparatus 1 of the present embodiment, the determination unit 7 determines the state of each of the discharge sections D[1] to D[M]. Therefore, when an abnormality occurs in the discharge section D including the piezoelectric element PZ, and when it is difficult to form an image at the medium P by the discharge section D in which no abnormality occurs, the image formation at the medium P by the liquid discharge apparatus 1 can be stopped. Therefore, the possibility that the discharge processing is continuously executed in a state in which the quality of the image formed at the medium P is deteriorated is reduced.

Further, in the liquid discharge apparatus 1 of the present embodiment, since the sink capacity in the sink circuit 40 is constant, when the voltage value of the wiring Lb rises due to a factor other than the abnormality of the discharge section D including the piezoelectric element PZ, the rise of the voltage value is detected by an overvoltage detection circuit (not illustrated) or the like, and thus, the image formation at the medium P in the liquid discharge apparatus 1 can be stopped. Therefore, the possibility that the discharge processing is continuously executed in a state in which the quality of the image formed at the medium P is deteriorated is reduced.

As described above, in the liquid discharge apparatus 1 of the present embodiment, the continuation and stopping of image formation at the medium P can be appropriately switched. Therefore, the possibility that the productivity and the convenience of the liquid discharge apparatus 1 are reduced can be reduced, and the possibility that the quality of the image formed at the medium P in the liquid discharge apparatus 1 is reduced can also be reduced.

In addition, in the liquid discharge apparatus 1 of the present embodiment, the determination unit 7 determines the state of the plurality of discharge sections D according to the residual vibration generated in the plurality of discharge sections D. Therefore, the state of the discharge sections D[1] to D[M] can be individually determined with high accuracy. Therefore, the accuracy of determining the state of the plurality of discharge sections D in the determination unit 7 is improved. Therefore, in the liquid discharge apparatus 1 of the present embodiment, the possibility that the productivity and the convenience are reduced can be further reduced, and the possibility that the quality of the image formed at the medium P is reduced can be further reduced.

Hitherto, the embodiments and the modification examples are described. However, the present disclosure is not limited to the embodiments, and can be implemented in various aspects within the scope not departing from the concept of the present disclosure. For example, the embodiments described above can also be combined with each other as appropriate.

The present disclosure includes substantially the same configurations (for example, configurations having the same functions, methods, and results, or configurations having the same objects and effects) as the configurations described in the embodiments. In addition, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. In addition, the present disclosure includes configurations in which a known technology is added to the configurations described in the embodiments.

The following contents are derived from the above-described embodiments.

A liquid discharge apparatus according to an aspect includes a print head having a plurality of discharge sections including a first discharge section configured to discharge a liquid by driving a first piezoelectric element and a second discharge section configured to discharge the liquid by driving a second piezoelectric element, a drive circuit configured to output a drive signal supplied to one end of the first piezoelectric element and one end of the second piezoelectric element, a reference voltage circuit configured to output a reference voltage signal supplied to another end of the first piezoelectric element and another end of the second piezoelectric element, a first switch circuit configured to switch whether or not to supply the drive signal to the one end of the first piezoelectric element, a second switch circuit configured to switch whether or not to supply the drive signal to the one end of the second piezoelectric element, a state determination circuit configured to determine a state of the plurality of discharge sections, and a sink circuit configured to switch an impedance value between a first wiring through which the reference voltage signal propagates and a second wiring through which a signal having a lower potential than the reference voltage signal propagates, in which when the state determination circuit determines that an abnormality occurs in the first discharge section, the first switch circuit does not supply the drive signal to the first piezoelectric element in a discharge period during which the liquid is discharged from the print head, and when the state determination circuit determines that the abnormality occurs in the second discharge section, the second switch circuit does not supply the drive signal to the second piezoelectric element in the discharge period.

In the liquid discharge apparatus, when the state determination circuit that determines the state of the plurality of discharge sections determines that an abnormality occurs in the first discharge section, the first switch circuit does not supply the drive signal to the one end of the first piezoelectric element included in the first discharge section, in a discharge period during which the liquid is discharged from the print head, and when the state determination circuit determines that the abnormality occurs in the second discharge section, the second switch circuit does not supply the drive signal to the one end of the second piezoelectric element included in the second discharge section in the discharge period during which the liquid is discharged from the print head. As a result, even when the abnormality such as a short-circuit abnormality occurs in one of the first piezoelectric element and the second piezoelectric element, the possibility that a surplus current flows into the first wiring through which the reference voltage signal propagates is reduced. Therefore, the possibility that the voltage value of the first wiring rises due to the occurrence of the short-circuit abnormality in the first piezoelectric element included in the first discharge section is reduced, and similarly, the possibility that the surplus current flows into the first wiring due to the occurrence of the short-circuit abnormality in the second piezoelectric element included in the second discharge section is reduced. That is, in the liquid discharge apparatus, when the short-circuit abnormality occurs in any of the piezoelectric elements included in the plurality of discharge sections and when an image formation at a medium in the other discharge sections in which no abnormality occurs is possible, the image can be continuously formed without deteriorating the quality of the formed image.

Further, in the liquid discharge apparatus, the state determination circuit determines the state of each of the plurality of discharge sections. Accordingly, when the abnormality occurs in any one of the plurality of discharge sections each including the piezoelectric element, and when image formation at the medium is difficult by the discharge section in which no abnormality occurs, image formation at the medium can be stopped. Therefore, the possibility that the discharge processing is continuously executed in a state in which the quality of the image formed at the medium is deteriorated is reduced.

Further, in the liquid discharge apparatus, since the sink capacity in the sink circuit is constant, when the voltage value of the first wiring through which the reference voltage signal propagates rises due to a factor other than the abnormality of the discharge section including the piezoelectric element, the rise of the voltage value can be detected by an overvoltage detection circuit (not illustrated) or the like, and at this time, the image formation at the medium can be stopped. Therefore, the possibility that the discharge processing is continuously executed in a state in which the quality of the image formed at the medium is deteriorated is reduced.

As described above, in the liquid discharge apparatus of the present embodiment, the continuation and stopping of image formation at the medium can be appropriately switched. Therefore, the possibility that the productivity and the convenience of the liquid discharge apparatus are reduced can be reduced, and the possibility that the quality of the image formed at the medium in the liquid discharge apparatus is reduced can also be reduced.

In one aspect of the liquid discharge apparatus, the apparatus may further include a maintenance section configured to execute maintenance processing of the discharge section.

In one aspect of the liquid discharge apparatus, the maintenance section may be configured to execute, as the maintenance processing, wiping processing of wiping a discharge surface from which the liquid is discharged from the print head.

In one aspect of the liquid discharge apparatus, the maintenance section may be configured to execute, as the maintenance processing, flushing processing of discharging the liquid from the plurality of discharge sections to recover a viscosity of the stored liquid.

In these liquid discharge apparatuses, the maintenance section that executes the maintenance processing of recovering the state of the discharge section is provided, and by executing, as the maintenance processing, the wiping processing of wiping the discharge surface from which the ink is discharged from the print head or the flushing processing of simultaneously discharging the liquid from the plurality of discharge sections to recover the viscosity of the stored liquid, even when the state of the discharge section is recovered, the first switch circuit and the second switch circuit are controlled according to the determination result of the state of the plurality of discharge sections in the state determination circuit, and thus, the continuation and stopping of the image formation at the medium can be controlled to the optimal state based on the state of the plurality of the discharge sections. Therefore, the possibility that the productivity and the convenience of the liquid discharge apparatus are reduced can be further reduced, and the possibility that the quality of the image formed at the medium is reduced can be further reduced.

In one aspect of the liquid discharge apparatus, the drive circuit may include a class D amplifier circuit.

In one aspect of the liquid discharge apparatus, the sink circuit may include discrete components.

In one aspect of the liquid discharge apparatus, when the state determination circuit determines that the abnormality occurs in the first discharge section, among the plurality of discharge sections, a third discharge section, which is located adjacent to the first discharge section and is determined by the state determination circuit not to have the abnormality, may be configured to discharge the liquid to complement the first discharge section in the discharge period.

In one aspect of the liquid discharge apparatus, the state determination circuit may determine a state of the first discharge section according to a residual vibration generated in the first discharge section, and determine a state of the second discharge section according to a residual vibration generated in the second discharge section.

In the liquid discharge apparatus, the state determination circuit determines a state of the first discharge section according to a residual vibration generated in the first discharge section, and determines a state of the second discharge section according to a residual vibration generated in the second discharge section. Therefore, the state of the plurality of discharge sections can be determined individually with high accuracy. Therefore, the accuracy of determining the state of the plurality of discharge sections in the state determination circuit is improved, and the continuation and stopping of the image formation at the medium can be controlled to the optimal state based on the latest states of the plurality of discharge sections. Therefore, the possibility that the productivity and the convenience of the liquid discharge apparatus are reduced can be further reduced, and the possibility that the quality of the image formed at the medium is reduced can be further reduced.

In one aspect of the liquid discharge apparatus, the sink circuit may include a switch circuit and a resistive element, one end of the switch circuit may be electrically coupled to the first wiring, another end of the switch circuit may be electrically coupled to one end of the resistive element, and another end of the resistive element may be electrically coupled to the second wiring.

What is claimed is:

1. A liquid discharge apparatus comprising:
a print head having a plurality of discharge sections including a first discharge section configured to discharge a liquid by driving a first piezoelectric element and a second discharge section configured to discharge the liquid by driving a second piezoelectric element;
a drive circuit configured to output a drive signal supplied to one end of the first piezoelectric element and one end of the second piezoelectric element;
a reference voltage circuit configured to output a reference voltage signal supplied to another end of the first piezoelectric element and another end of the second piezoelectric element;
a first switch circuit configured to switch whether or not to supply the drive signal to the one end of the first piezoelectric element;
a second switch circuit configured to switch whether or not to supply the drive signal to the one end of the second piezoelectric element;
a state determination circuit configured to determine a state of the plurality of discharge sections; and
a sink circuit configured to switch an impedance value between a first wiring through which the reference voltage signal propagates and a second wiring through which a signal having a lower potential than the reference voltage signal propagates, wherein
when the state determination circuit determines that an abnormality occurs in the first discharge section, the first switch circuit does not supply the drive signal to the first piezoelectric element in a discharge period during which the liquid is discharged from the print head, and
when the state determination circuit determines that the abnormality occurs in the second discharge section, the second switch circuit does not supply the drive signal to the second piezoelectric element in the discharge period.

2. The liquid discharge apparatus according to claim 1, further comprising:
a maintenance section configured to execute maintenance processing of the discharge section.

3. The liquid discharge apparatus according to claim 2, wherein
the maintenance section is configured to execute, as the maintenance processing, wiping processing of wiping a discharge surface from which the liquid is discharged from the print head.

4. The liquid discharge apparatus according to claim 2, wherein
the maintenance section is configured to execute, as the maintenance processing, flushing processing of discharging the liquid from the plurality of discharge sections to recover a viscosity of the stored liquid.

5. The liquid discharge apparatus according to claim 1, wherein
the drive circuit includes a class D amplifier circuit.

6. The liquid discharge apparatus according to claim 1, wherein
the sink circuit includes discrete components.

7. The liquid discharge apparatus according to claim 1, wherein
when the state determination circuit determines that the abnormality occurs in the first discharge section, among the plurality of discharge sections, a third discharge section, which is located adjacent to the first discharge section and is determined by the state determination circuit not to have the abnormality, is configured to discharge the liquid to complement the first discharge section in the discharge period.

8. The liquid discharge apparatus according to claim 1, wherein
the state determination circuit determines a state of the first discharge section according to a residual vibration generated in the first discharge section, and determines a state of the second discharge section according to a residual vibration generated in the second discharge section.

9. The liquid discharge apparatus according to claim 1, wherein
the sink circuit includes a switch circuit and a resistive element,
one end of the switch circuit is electrically coupled to the first wiring,
another end of the switch circuit is electrically coupled to one end of the resistive element, and
another end of the resistive element is electrically coupled to the second wiring.
